(19) United States
(12) Patent Application Publication
(10) Pub. No.: US 2013/0177296 A1
(43) Pub. Date: Jul. 11, 2013

(54) GENERATING METADATA FOR USER EXPERIENCES

(71) Applicants: Kevin A. Geisner, Mercer Island, WA (US); Relja Markovic, Seattle, WA (US); Stephen G. Latta, Seattle, WA (US); Daniel McCulloch, Kirkland, WA (US)

(72) Inventors: Kevin A. Geisner, Mercer Island, WA (US); Relja Markovic, Seattle, WA (US); Stephen G. Latta, Seattle, WA (US); Daniel McCulloch, Kirkland, WA (US)

(21) Appl. No.: 13/689,413

(22) Filed: Nov. 29, 2012

Related U.S. Application Data
(63) Continuation of application No. 13/296,585, filed on Nov. 15, 2011, now abandoned.

(51) Int. Cl. H04N 9/80

(52) U.S. Cl. CPC H04N 9/80
USPC 386/241

(57) ABSTRACT

A system and method for efficiently managing life experiences captured by one or more sensors (e.g., video or still camera, image sensors including RGB sensors and depth sensors). A “life recorder” is a recording device that continuously captures life experiences, including unanticipated life experiences, in image, video, and/or audio recordings. In some embodiments, video and/or audio recordings captured by a life recorder are automatically analyzed, tagged with a set of one or more metadata, indexed, and stored for future use. By tagging and indexing life recordings, a life recorder may search for and acquire life recordings generated by itself or another life recorder, thereby allowing life experiences to be shared minutes or even years later.

### CLAIM OF PRIORITY

This application is a continuation application of co-pending U.S. patent application Ser. No. 13/296,585, entitled “GENERATING METADATA FOR USER EXPERIENCES,” by Geisner et al., filed Nov. 15, 2011, incorporated herein by reference in its entirety.

### BACKGROUND

Today's mobile devices such as cell phones and digital cameras are capable of capturing and storing large amounts of content. For example, the proliferation of camera technology combined with interchangeable memory devices enables many digital camera users to capture and store more life experiences than was previously feasible.

A near-eye display such as a head mounted display (HMD) with forward facing cameras may be worn by a user to continuously capture life experiences, including unanticipated life experiences, in image, video, and/or audio recordings. It would be useful to efficiently manage the image, video, and/or audio recordings captured by a head mounted display, thereby allowing life experiences to be shared minutes or even years later.

### SUMMARY

Technology is described for efficiently managing life experiences captured by one or more sensors (e.g., video or still camera, one or more image sensors including RGB sensors and depth sensors, and/or other image sensors). For example, a “life recorder” is a recording device that continuously captures life experiences, including unanticipated life experiences, in image, video, and/or audio recordings. In some embodiments, the video and/or audio recordings generated by a life recorder are automatically analyzed, tagged with a set of one or more metadata, indexed, and stored for future use. By tagging and indexing life recordings, a life recorder or other device may later search for and acquire life recordings generated by itself or another life recorder, thereby allowing life experiences to be shared minutes or even years later.

In some embodiments, upon detection of the particular situation or event, the life recorder may automatically generate a set of one or more metadata tags for a portion of the life recording captured by the life recorder based on the context information associated with the life recording and/or one or more particular situations identified from the life recording.

One embodiment includes acquiring a recording of user experiences captured throughout one or more days by a recording device, generating context information including information associated with a user of the recording device and information associated with the recording device by one or more sensors, identifying a particular situation from the recording, detecting a tag event including automatically determining whether one or more rules for determining when to generate a set of one or more metadata tags for the recording are satisfied by the context information and the particular situation, and automatically generating a set of one or more metadata tags for the recording responsive to the step of detecting. Each of the one or more metadata tags includes one or more keywords that describe the recording related to a location associated with the recording device, a timestamp associated with the recording, an event associated with the user, and/or a situation associated with the recording. The set of one or more metadata tags allows subsequent search of the recording by the user or another user associated with one or more different recording devices.

One embodiment includes capturing one of a video recording, an audio recording, or an audiovisual recording of user experiences associated with a user by one or more recording devices, analyzing the recording including detecting a particular situation from the recording and comparing the particular situation detected with one or more requirements to determine when to generate a set of one or more metadata tags for the recording, identifying a first portion of the recording during which the particular situation is detected responsive to the step of analyzing, and automatically determining a set of one or more metadata tags to be associated with the first portion of the recording including generating one or more key phrases describing the first portion of the recording such that the recording can be searched based on the one or more key phrases.

On embodiment includes one or more video devices, a memory and one or more processors. The one or more video devices capture a recording of user experiences associated with a user. The memory stores the recording of user experiences. The one or more processors are in communication with the one or more video devices and the memory. The one or more processors receive one or more rules, analyze the recording to detect context information associated with the recording and to identify a particular situation from the recording, determine when to generate a set of one or more metadata tags for the recording by comparing the set of one or more rules with the context information and the particular situation, and generate a set of one or more metadata tags to be associated with a portion of the recording during which the particular situation was identified.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram of one embodiment of a networked computing environment in which the disclosed technology may be practiced.

FIG. 1B depicts the use of mobile life recorders to record a person's life experiences.

FIG. 1C depicts the use of a non-mobile life recorder in a home environment.

FIG. 2A depicts one embodiment of a portion of a head-mounted life recorder.

FIG. 2B illustrates one embodiment of a life recorder including a capture device and computing environment.

FIG. 3 is a flowchart describing one embodiment of a process according to an embodiment of the present technology.

FIG. 3A is a flowchart describing one embodiment of a process for acquiring a life recording of one or more life experiences associated with a user.

FIG. 3B is a flowchart describing one embodiment of a process for adding a set of one or more metadata tags to a life recording.

FIG. 4A is a flowchart describing one embodiment of a process for analyzing a life recording captured by a life recorder.

FIG. 4B is a flowchart describing one embodiment of a process for generating context information associated with a life recording.

FIG. 4C is a flowchart describing one embodiment of a process for identifying a particular situation associated with a life recording.

FIG. 4D is a flowchart describing one embodiment of a process for automatically detecting the existence of a tag event.

FIG. 5 depicts one embodiment of a tag filter and a metadata tag file.

FIG. 6 depicts one embodiment of a configuration page for a user to configure various settings and preferences related to metadata tagging.

FIG. 7 is a block diagram of an embodiment of a gaming and media system.

FIG. 8 is a block diagram of an embodiment of a mobile device.

FIG. 9 is a block diagram of an embodiment of a computing system environment.

### DETAILED DESCRIPTION

Technology is described for efficiently managing life experiences captured by one or more sensors (e.g., video or still camera, one or more image sensors including RGB sensors and depth sensors). A “life recorder” is a recording device that continuously captures life experiences, including unanticipated life experiences, in image, video, and/or audio recordings. In some embodiments, video and/or audio recordings generated by a life recorder are automatically analyzed, tagged with a set of one or more metadata, indexed, and stored for future use. By tagging and indexing life recordings, a life recorder or other computing device may search for and acquire life recordings generated by itself or another life recorder, thereby allowing life experiences to be shared minutes or even years later. In some embodiments, upon detection of a particular situation or event, a life recorder may automatically generate a set of one or more metadata tags for a portion of the life recording captured by the life recorder based on context information associated with the life recording and/or one or more particular situations identified from the life recording.

The metadata tags generated for life recordings captured by a life recorder may be indexed and stored in a searchable digital archive. The searchable digital archive may comprise a remote storage and/or application server. A searchable digital archive of metadata tags has many practical applications including allowing users of a computing device to search for and download life recordings associated with when and where they spent their last vacation, whom they have met on a recent trip to Hawaii, and what was said during a conversation with a particular individual. The metadata tags generated for life recordings captured by a life recorder may also be searched by users of one or more different life recorders or computing devices, thereby allowing the users of one or more different life recorders or computing devices to search for and download life recordings captured by the life recorder. With a searchable digital archive, people no longer need to rely on their sometimes faulty or inaccurate memories when sharing or reliving life experiences.

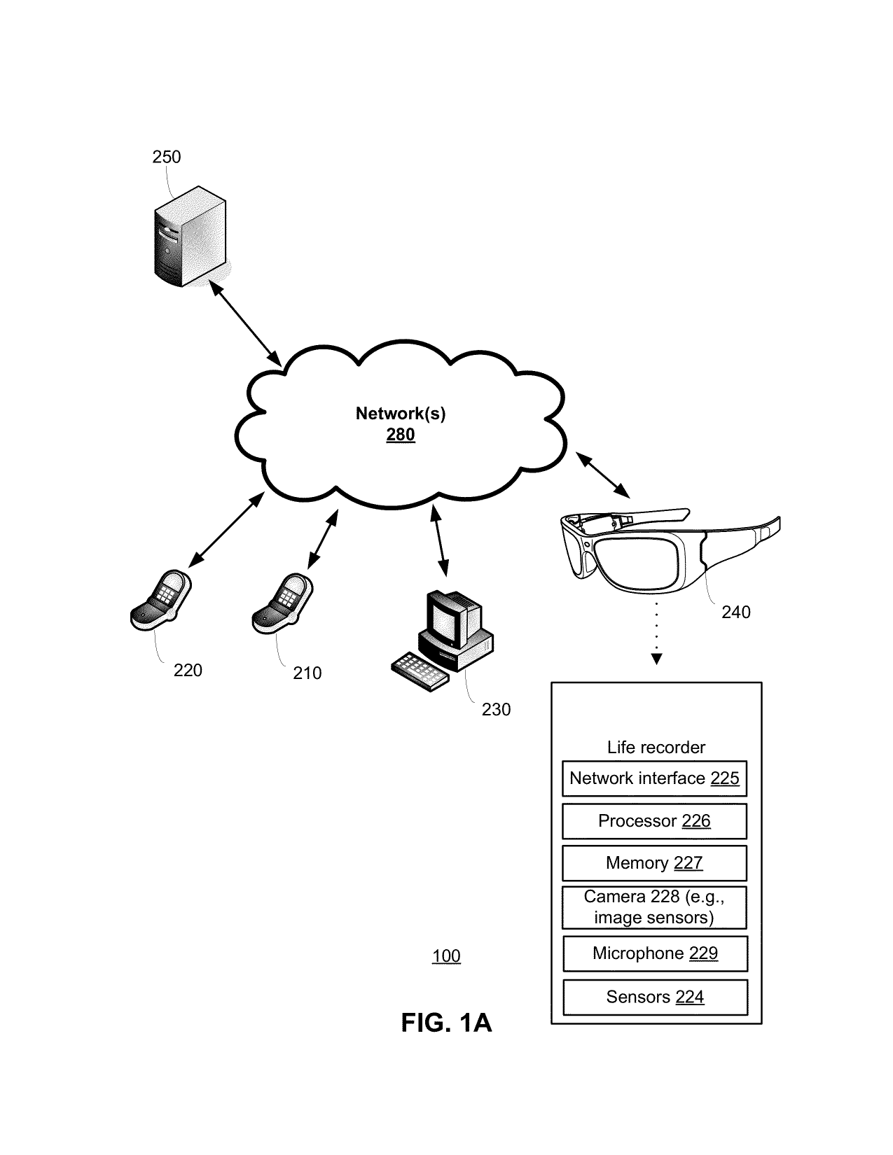

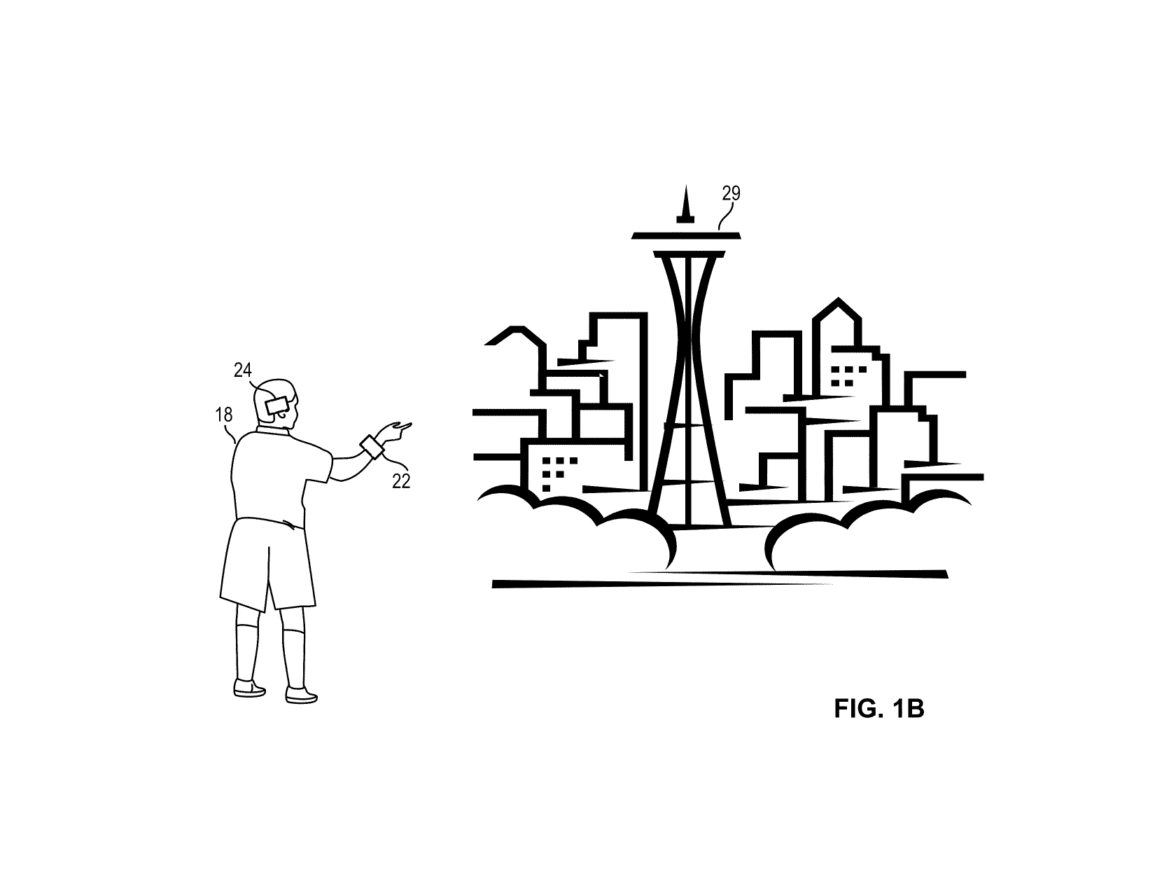

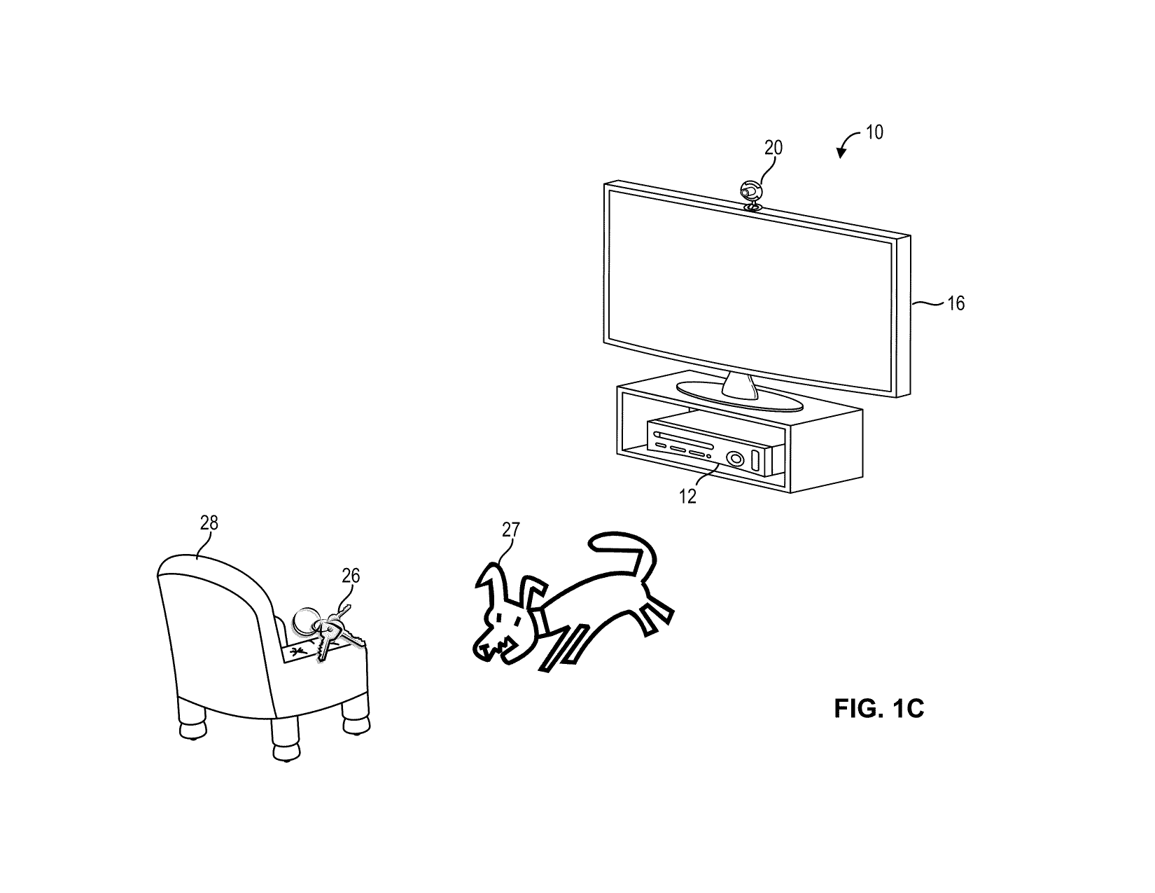

FIG. 1A is a block diagram of one embodiment of a networked computing environment 100 in which the disclosed technology may be practiced. Networked computing environment 100 includes a plurality of computing devices interconnected through one or more networks 280. The one or more networks 280 allow a particular computing device to connect to and communicate with another computing device. The depicted computing devices include life recorder 240, mobile devices 220 and 210, desktop computer 230, and application server 250. In some embodiments, the plurality of computing devices may include other computing devices not shown. In some embodiments, the plurality of computing devices may include more than or less than the number of computing devices shown in FIG. 1A. The one or more networks 280 may include a secure network such as an enterprise private network, an unsecure network such as a wireless open network, a local area network (LAN), a wide area network (WAN), and the Internet. Each network of the one or more networks 280 may include hubs, bridges, routers, switches, and wired transmission media such as a wired network or direct-wired connection.

An application server, such as application server 250, may allow a client to download content (e.g., audio, image, and video files) from the application server or to perform a search query related to the content. In one example, a client may download video and audio recordings associated with (e.g., received from) a life recorder. In general, a “server” may include a hardware device that acts as the host in a client-server relationship or a software process that shares a resource with or performs work for one or more clients. Communication between computing devices in a client-server relationship may be initiated by a client sending a request to the server asking for access to a particular resource or for particular work to be performed. The server may subsequently perform the actions requested and send a response back to the client.

One embodiment of life recorder 240 includes a camera 228, microphone 229, sensors 224, network interface 225, processor 226, and memory 227, all in communication with each other. Camera 228 may capture digital images and/or videos. In one embodiment, camera 228 may include one or more image sensors such as an RGB sensor, a depth sensor, and/or other image sensors. Microphone 229 may capture sounds. Sensors 224 may capture unique human subject data including biological and physiological properties associated with a user of life recorder 240 such as body temperature, heart rate, galvanic skin response, blood volume pulse, respiration, pupillary response, and so on. Sensors 224 may also capture environmental data associated with the life recording at the time of recording such as geographic positioning using Global Positioning System (GPS), time information, weather data such as wind speed, temperature, humidity, detection of smoke, flames, traffic speed and direction, and so on. Life recorder 240 may be pointed towards the real world to capture one or more real world objects or pointed back at a user or wearer of the life recorder 240 (e.g., for eye tracking or gaze detection). Network interface 225 allows life recorder 240 to connect to one or more networks 280. Network interface 225 may include a wireless network interface, a modem, and/or a wired network interface. Processor 226 allows life recorder 240 to execute computer readable instructions stored in memory 227 to perform the processes discussed herein.

Networked computing environment 100 may provide a cloud computing environment for one or more computing devices. Cloud computing refers to Internet-based computing, wherein shared resources, software, and/or information are provided to one or more computing devices on-demand via the Internet (or other global network). The term “cloud” is used as a metaphor for the Internet, based on the cloud drawings used in computer network diagrams to depict the Internet as an abstraction of the underlying infrastructure it represents.

In one embodiment, life recorder 240 captures a life recording, buffers and analyzes the life recording in real-time, and automatically associate the life recording with a set of one or more metadata tags. A set of one or more metadata tags may be generated for a life recording based on the context information associated with the life recording and/or a particular condition identified from the life recording. In another embodiment, application server 250 is used as a remote storage server for life recordings. By indexing and storing life recordings on application server 250, other computing devices, such as desktop computer 230, may search for and download life recordings associated with other life recorders such as life recorder 240.

FIG. 1B depicts the use of mobile life recorders to record a person's life experiences. Mobile life recorders are typically unobtrusive and lightweight such that one or more mobile life recorders may be attached to a person or their clothing. In FIG. 1B, mobile life recorder 22 is attached to the wrist of user 18 and mobile life recorder 24 is attached to the ear of user 18. In one example, mobile life recorder 24 corresponds to life recorder 240 in FIG. 1A. A benefit of the positioning used by mobile life recorder 24 is that its capture range may be inline with the viewing range of user 18 (i.e., the visual recording may correspond with what user 18 was looking at). In one embodiment, mobile life recorder 22 may include one or more biometric sensors that are configured to sense one or more biometric signals originating from the user and identify various biological properties associated with the user such as body temperature, heart rate, galvanic skin response, blood volume pulse, respiration, pulse rate, and so on. By wearing mobile life recorders 22 and 24, user 18 may record his or her unique life experiences as they occur.

In one embodiment, mobile life recorder 24 generates a life recording and detects a particular object such as landmark object 29 in the life recording. Upon detection of the particular object such as landmark object 29 in the life recording, life recorder 24 may automatically generate one or more metadata tags, such as a first tag indicative of a particular geographical location associated with the life recorder at the time of recording (e.g., Seattle, Wash.), a second tag indicative of the particular date and time associated with the life recorder at the time of recording (e.g., 7:00 pm on Jul. 4, 2011), a third tag indicative of a particular event associated with the time of recording by the life recorder (e.g., July 4th fireworks celebrations), and automatically associate the one or more metadata tags with the life recording or a portion of the life recording associated with the time duration for which the particular objected was detected (e.g., upon detection of landmark object 29).

As will be discussed below, a set of one or more metadata tags may be generated for a life recording based on the context information associated with the life recording at the time of recording such as location information, time information, calendar information, biological and physiological information of the user, and other information associated with the life recording at the time of recording.

FIG. 1C depicts the use of a non-mobile life recorder in a home environment. Non-mobile life recorder 10 may be positioned within a room in a home, such as the living room, in order to continuously capture and record life experiences that occur within the room. In FIG. 1C, non-mobile life recorder 10 includes computing environment 12 and capture device 20, in communication with each other. Computing environment 12 may include one or more processors. Capture device 20 may include one or more image sensors, including an RGB sensor and depth sensors, which may be used to visually monitor one or more targets including humans and one or more objects including keys 26, chair 28, and dog 27. In one example, capture device 20 may include a webcam (or other video camera) and computing environment 12 may comprise a set-top box. Capture device 20 may be pointed towards the real world to capture one or more real world objects (e.g., keys 26, chair 28) or pointed to a user (e.g., for eye tracking or gaze detection). In one embodiment, life recorder 10 generates a life recording and detects a particular object (e.g., keys 26) or a particular situation (e.g., dog 27 jumping onto chair 28). Upon detection of the particular object or particular situation, life recorder 10 may automatically generate one or more metadata tags and associate the one or more metadata tags with the life recording or a portion of the life recording associated with the time duration during which the particular object or situation was detected. As will be discussed below, a set of one or more metadata tags may be generated for a life recording based on a particular object or situation identified from the life recording by using a variety of techniques such as voice recognition, speech recognition, object, pattern, and/or facial recognition, emotional detection, gesture detection, gaze detection, and/or machine learning techniques.

In one embodiment, capture device 20 may capture image and audio data relating to one or more targets and/or objects. For example, capture device 20 may be used to capture information relating to partial or full body movements, gestures, and speech of one or more users. The information captured by capture device 20 may be received by computing environment 12 and/or a processing element within capture device 20 and used to render, interact with, and control aspects of the life recorder. In one example, capture device 20 captures image and audio data relating to a particular user and processes the captured information to identify the particular user by executing facial and voice recognition software.

Suitable examples of life recorders, such as non-mobile life recorder 10, and components thereof may be found in the following co-pending patent applications, all of which are herein incorporated by reference in their entirety: U.S. patent application Ser. No. 12/475,094, entitled “Environment And/Or Target Segmentation,” filed May 29, 2009; U.S. patent application Ser. No. 12/511,850, entitled “Auto Generating a Visual Representation,” filed Jul. 29, 2009; U.S. patent application Ser. No. 12/474,655, entitled “Gesture Tool,” filed May 29, 2009; U.S. patent application Ser. No. 12/603,437, entitled “Pose Tracking Pipeline,” filed Oct. 21, 2009; U.S. patent application Ser. No. 12/475,308, entitled “Device for Identifying and Tracking Multiple Humans Over Time,” filed May 29, 2009, U.S. patent appication Ser. No. 12/575,388, entitled “Human Tracking System,” filed Oct. 7, 2009; U.S. patent application Ser. No. 12/422,661, entitled “Gesture Recognizer System Architecture,” filed Apr. 13, 2009; and U.S. patent application Ser. No. 12/391,150, entitled “Standard Gestures,” filed Feb. 23, 2009.

In one embodiment, the computing environment 12 and/or capture device 20 may be connected to an audiovisual device 16 such as a television, a monitor, or a high-definition television (HDTV) for displaying and/or playing one or more life recordings. In one example, the computing environment 12 may include a video adapter such as a graphics card and/or an audio adapter such as a sound card that may provide audiovisual signals associated with a computing application running on the life recorder. The audiovisual device 16 may receive the audiovisual signals from the computing environment 12 and may output visuals associated with one or more video recordings and audio signals associated with one or more audio recordings. In one embodiment, the audiovisual device 16 may be connected to computing environment 12 via, for example, an S-Video cable, a coaxial cable, an HDMI cable, a DVI cable, a VGA cable, or the like.

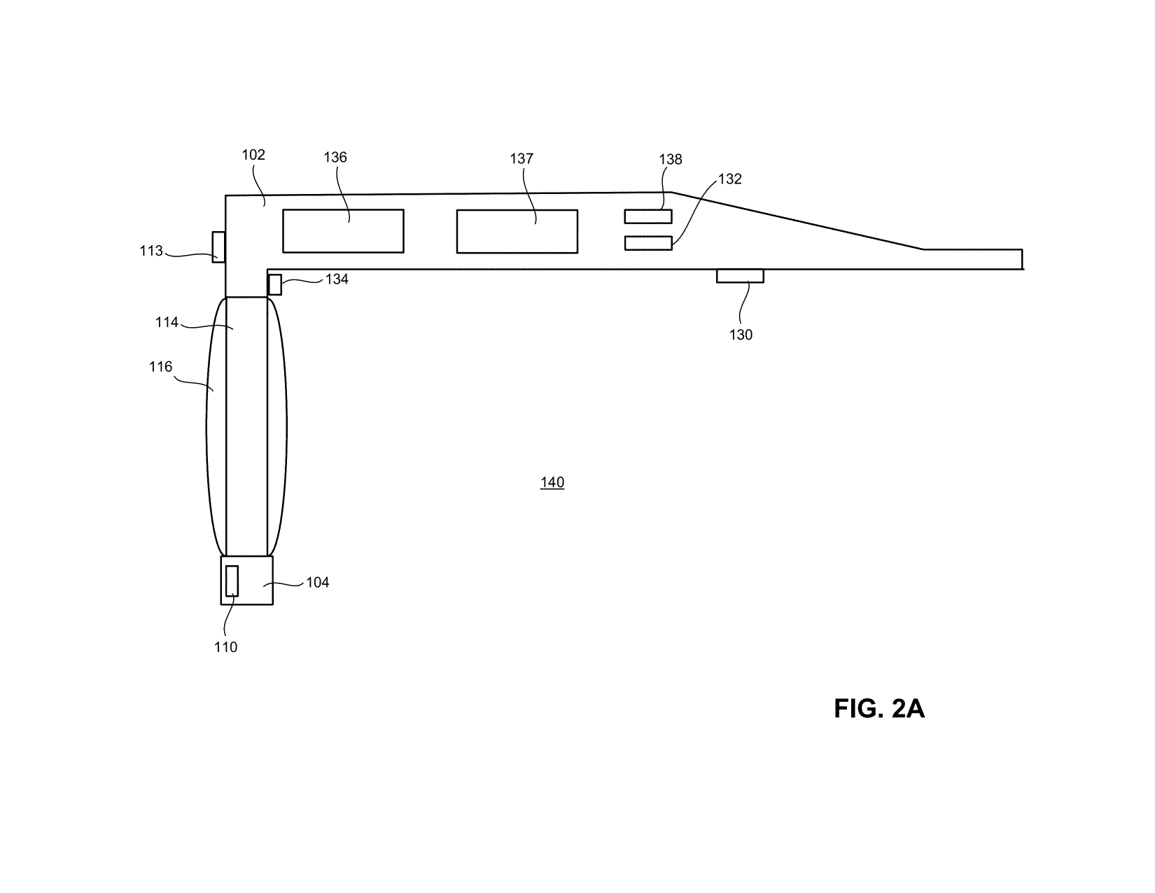

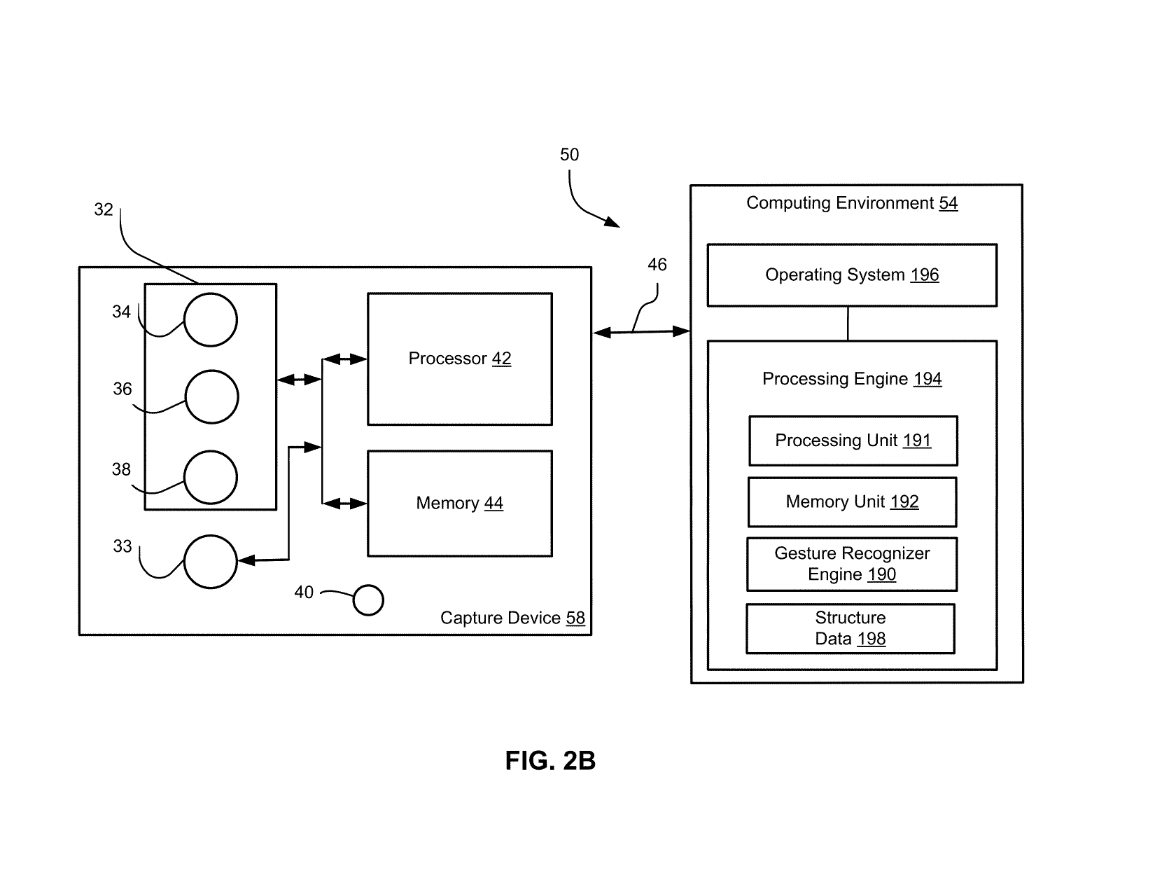

FIG. 2A depicts one embodiment of a portion of a head-mounted life recorder 140, such as life recorder 240 in FIG. 1A. Only the right side of head-mounted life recorder 140 is depicted. Head-mounted life recorder 140 includes right temple 102, nose bridge 104, eye glass 116, and eye glass frame 114. Built into nose bridge 104 is a microphone 110 for recording sounds and transmitting the audio recording to processing unit 136. A front facing camera 113 is embedded inside right temple 102 for recording digital images and videos and transmitting the visual recordings to processing unit 136. Front facing camera 113 and microphone 110 may be viewed as comprising a capture device similar to capture device 20 in FIG. 1C. Microphone 110 and front facing camera 113 are in communication with processing unit 136.

Head-mounted life recorder 140 may include an eye tracking system 134 for tracking the position of the user's eyes. In one embodiment, the system will track the user's position and orientation so that the system can determine the field of view of the user. However, a human will not perceive everything in front of them. Instead, a user's eyes will be directed at a subset of the environment. Therefore, in one embodiment, the system will include technology for tracking the position of the user's eyes in order to refine the measurement of the field of view of the user.

In one embodiment, eye tracking system 134 may include an eye tracking illumination device (not shown) for emitting IR light toward the eye and an eye tracking camera (also not shown) for sensing the reflected IR light. The position of the pupil can be identified by known imaging techniques which detect the reflection of the cornea. Generally, eye tracking involves obtaining an image of the eye and using computer vision techniques to determine the location of the pupil within the eye socket. In one embodiment, it is sufficient to track the location of one eye since the eye usually moves in unison. However, it is possible to track each eye separately. Alternatively, eye tracking camera may be an alternative form of tracking camera using any motion based image of the eye to detect position, with or without an illumination source. More information about eye tracking and/or gaze detection can be found in U.S. Pat. No. 7,401,920, “Head Mounted Eye Tracking and Display System”, issued Jul. 22, 2008 to Kranz et al.; and U.S. patent application Ser. No. 13/221,739, “Gaze Detection in a See-Through, Near-Eye, Mixed Reality Display” filed on Aug. 30, 2011, both of which are incorporated by reference herein in their entirety.

Also embedded inside right temple 102 are ear phones 130, motion and orientation sensor 138, temperature sensor 132, and wireless interface 137, all in communication with processing unit 136. Motion and orientation sensor 138 may include a three axis magnetometer, a three axis gyro, and a three axis accelerometer. Processing unit 136 may include one or more processors and a memory for storing computer readable instructions to be executed on the one or more processors. Processing unit 136 may be viewed as comprising a computing environment similar to computing environment 12 in FIG. 1C. Further details of capture devices and computing environments will be described below with reference to FIG. 2B.

FIG. 2B illustrates one embodiment of a life recorder 50 including a capture device 58 and computing environment 54. Life recorder 50 may be a mobile life recorder or a non-mobile life recorder. In one example, computing environment 54 corresponds with computing environment 12 in FIG. 1C and capture device 58 corresponds with capture device 20 in FIG. 1C. In another example, and with reference to mobile life recorders 22 and 24 in FIG. 1B, capture device 58 and computing environment 54 may be integrated within a single housing.

In one embodiment, capture device 58 may include one or more image sensors for capturing images and videos. An image sensor may comprise a CCD image sensor or a CMOS sensor. In some embodiments, capture device 58 may include an IR CMOS image sensor. Capture device 58 may also include a depth sensor (or depth sensing camera) configured to capture video with depth information including a depth image that may include depth values via any suitable technique including, for example, time-of-flight, structured light, stereo image, or the like.

Capture device 58 may include an image camera component 32. In one embodiment, image camera component 32 may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

Image camera component 32 may include an IR light component 34, a three-dimensional (3-D) camera 36, and an RGB camera 38 (i.e., RGB sensor) that may be used to capture the depth image of a capture area. For example, in time-of-flight analysis, IR light component 34 of capture device 58 may emit an infrared light onto the capture area and may then use sensors to detect the backscattered light from the surface of one or more targets and objects in the capture area using, for example, 3-D camera 36 and/or RGB camera 38. In some embodiments, pulsed infrared light may be used such that the time between an outgoing light pulse and a corresponding incoming light pulse may be measured and used to determine a physical distance from capture device 58 to a particular location on the targets or objects in the capture area. Additionally, the phase of the outgoing light wave may be compared to the phase of the incoming light wave to determine a phase shift. The phase shift may then be used to determine a physical distance from the capture device to a particular location on the targets or objects.

In another example, capture device 58 may use structured light to capture depth information. In such an analysis, patterned light (i.e., light displayed as a known pattern such as grid pattern or a stripe pattern) may be projected onto the capture area via, for example, IR light component 34. Upon striking the surface of one or more targets (or objects) in the capture area, the pattern may become deformed in response. Such a deformation of the pattern may be captured by, for example, 3-D camera 36 and/or RGB camera 38 and analyzed to determine a physical distance from the capture device to a particular location on the targets or objects.

In some embodiments, two or more different cameras may be incorporated into an integrated capture device. For example, a depth camera and a video camera (e.g., an RGB video camera) may be incorporated into a common capture device. In some embodiments, two or more separate capture devices of the same or differing types may be cooperatively used. For example, a depth camera and a separate video camera may be used, two video cameras may be used, two depth cameras may be used, two RGB cameras may be used or any combination and number of cameras may be used. In one embodiment, capture device 58 may include two or more physically separated cameras that may view a capture area from different angles to obtain visual stereo data that may be resolved to generate depth information. Depth may also be determined by capturing images using a plurality of detectors that may be monochromatic, infrared, RGB, or any other type of detector and performing a parallax calculation. Other types of depth image sensors can also be used to create a depth image.

In some embodiment, capture device 58 may include one or more other sensors 33 such as eye tracking sensors, GPS sensors, and/or biological sensors for sensing unique human and environment information associated with a user of life recorder 50 at the time of life recording. The human and environment information may include biological and physiological properties associated with the user of life recorder 50 at the time of life recording such as body temperature, heart rate, galvanic skin response, blood volume pulse, respiration, pupillary response, and so on. The environment information may include information associated with the life recording at the time of recording such as geographic positioning using Global Positioning System (GPS), time information, weather data such as wind speed, temperature, humidity, detection of smoke, flames, traffic speed and direction, and so on.

As shown in FIG. 2B, capture device 58 may include a microphone 40. Microphone 40 may include a transducer or sensor that may receive and convert sound into an electrical signal. In one embodiment, microphone 40 may be used to reduce feedback between capture device 58 and computing environment 54 in life recorder 50. Additionally, microphone 40 may be used to receive audio signals that may also be provided by the user to control applications such as life recording applications or the like that may be executed by computing environment 54.

In one embodiment, capture device 58 may include a processor 42 that may be in operative communication with image camera component 32 and sensors 33. Processor 42 may include a standardized processor, a specialized processor, a microprocessor, or the like. Processor 42 may execute instructions that may include instructions for storing filters or profiles, receiving and analyzing images and other information or data, determining whether a particular situation has occurred, or any other suitable instructions. It is to be understood that at least some image analysis and/or target analysis and tracking operations may be executed by processors contained within one or more capture devices such as capture device 58.

Capture device 58 may include a memory component 44 that may store the instructions that may be executed by processor 42, images or frames of images captured by the 3-D camera or RGB camera, life recorder filters or profiles, or any other suitable information captured or sensed by capture device 58. In one example, memory component 44 may include random access memory (RAM), read only memory (ROM), cache, Flash memory, a hard disk, or any other suitable storage component. As shown in FIG. 2B, memory component 44 may be a separate component in communication with image capture component 32, sensors 33, and processor 42. In another embodiment, memory component 44 may be integrated into processor 42 and/or image capture component 32. In one embodiment, some or all of the components 32, 33, 34, 36, 38, 40, 42 and 44 of capture device 58 illustrated in FIG. 2B are housed in a single housing.

Capture device 58 may be in communication with computing environment 54 via a communication link 46. Communication link 46 may be a wired connection including, for example, a USB connection, a FireWire connection, an Ethernet cable connection, or the like and/or a wireless connection such as a wireless 802.11b, g, a, or n connection. Computing environment 54 may provide a clock to capture device 58 that may be used to determine when to capture, for example, a scene via the communication link 46. In one embodiment, capture device 58 may provide the images captured by, for example, 3-D camera 36 and/or RGB camera 38 to computing environment 54 via communication link 46.

As shown in FIG. 2B, computing environment 54 includes processing engine 194 in communication with operating system 196. Processing engine 194 includes gesture recognizer engine 190, structure data 198, processing unit 191, and memory unit 192, all in communication with each other. Processing engine 194 processes video, image, audio and other data received from capture device 58. To assist in the detection and/or tracking of objects, processing engine 194 may utilize structure data 198 and gesture recognition engine 190.

Processing unit 191 may include one or more processors for executing object, facial, and voice recognition algorithms. In one embodiment, processing engine 194 may apply object recognition and facial recognition techniques to image or video data. For example, object recognition may be used to detect particular objects (e.g., soccer balls, cars, or landmarks) and facial recognition may be used to detect the face of a particular person. Processing engine 194 may apply audio and voice recognition techniques to audio data. For example, audio recognition may be used to detect a particular sound or word being uttered and voice recognition may be used to detect the voice of a particular person. The particular faces, voices, sounds, and objects to be detected may be stored in one or more memories contained in memory unit 192.

Processing unit 191 may also include one or more processors for executing eye tracking algorithms. In one embodiment, processing engine 194 may apply eye tracking algorithms to eye tracking data received from sensors 33. For example, eye tracking algorithm may be used to detect the focus of the user's eyes at the time of life recording (i.e., gaze detection), thereby inferring whether the user has shown interest in a particular individual or object. In one embodiment, eye tracking data may be correlated with one or more recognized gestures such as head gestures, eye gestures, hand gestures, and other recognized gestures. In one embodiment, one or more gestures may be identified by a gesture recognizer engine such as gesture recognizer engine 190 as discussed below.

In some embodiments, one or more objects being tracked may be augmented with one or more markers such as an IR retro-reflective marker to improve object detection and/or tracking. Upon detection of one or more targets or objects, processing engine 194 may report to operating system 196 an identification of each object detected and a corresponding position and/or orientation.

Processing engine 194 may utilize structural data 198 while performing object recognition. Structure data 198 may include structural information about targets and/or objects to be tracked. For example, a skeletal model of a human may be stored to help recognize body parts. In another example, structure data 198 may include structural information regarding one or more inanimate objects in order to help recognize the one or more inanimate objects.

Processing engine 194 may also utilize gesture recognizer engine 190 while performing object recognition. In one example, gestures recognizer engine 190 may include a collection of gesture filters, each comprising information concerning a gesture that may be performed by a skeletal model. Gesture recognition engine 190 may compare the data captured by capture device 58 in the form of the skeletal model and movements associated with it to the gesture filters in gesture library 192 to identify when a user (as represented by the skeletal model) has performed one or more gestures. In one example, image and audio processing engine 194 may use gesture recognition engine 190 to help interpret movements of a skeletal model and to detect the performance of a particular gesture.

More information about gesture recognizer engine 190 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23,2009; and U.S. patent application Ser. No. 12/474,655, “Gesture Tool” filed on May 29, 2009, both of which are incorporated by reference herein in their entirety. More information about motion detection and tracking can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety.

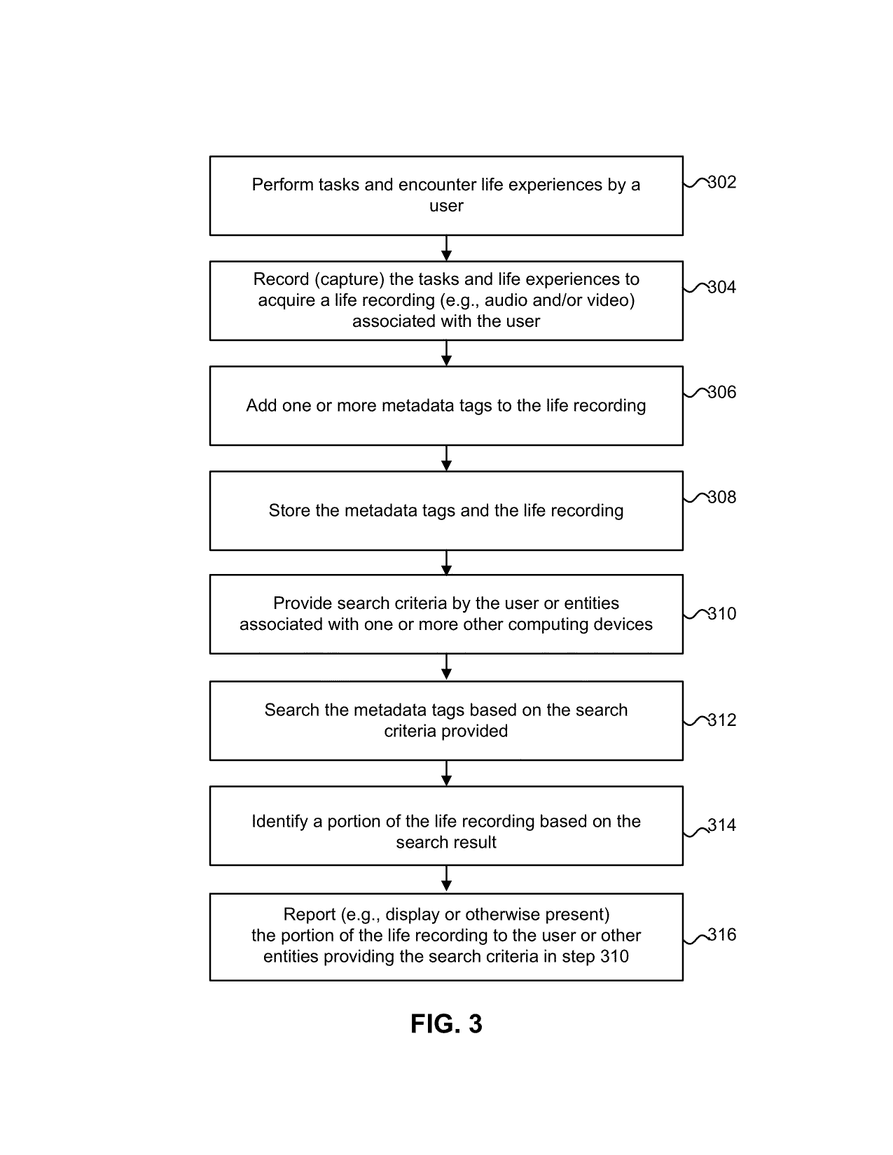

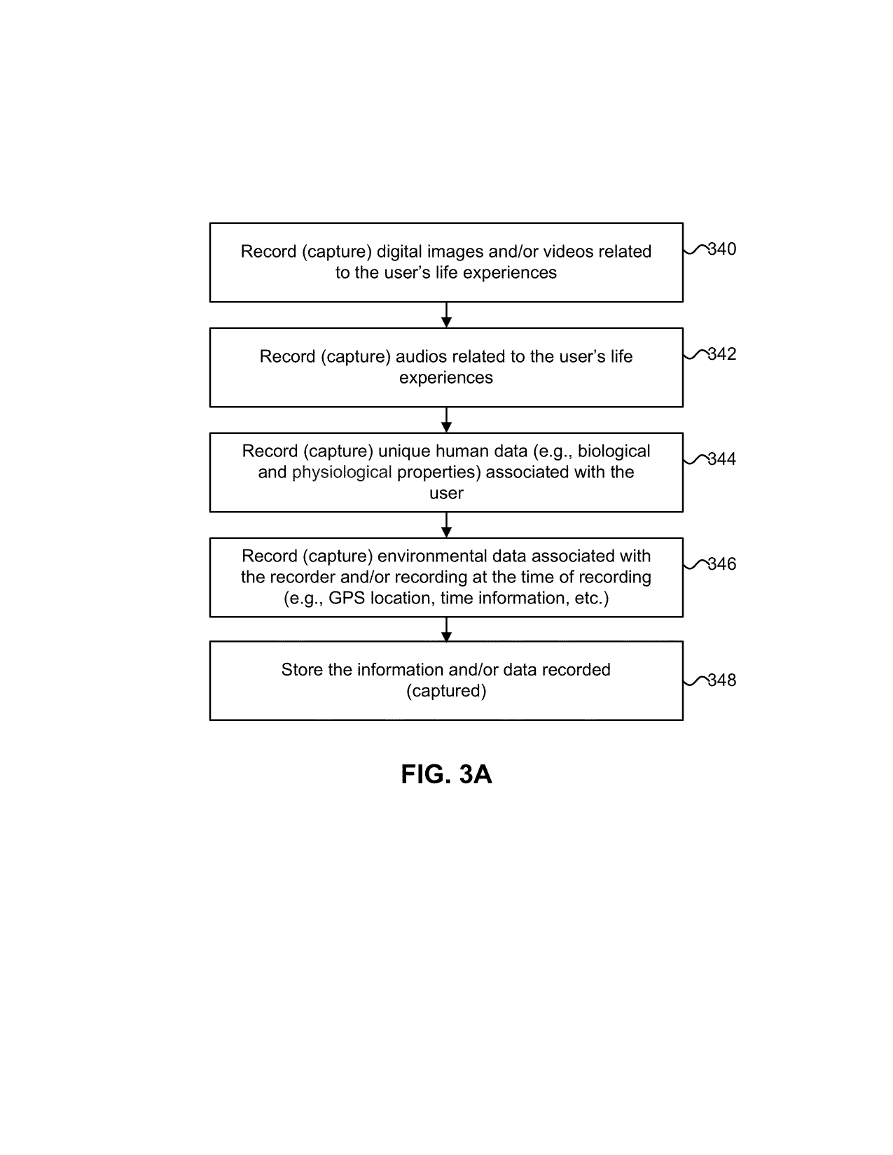

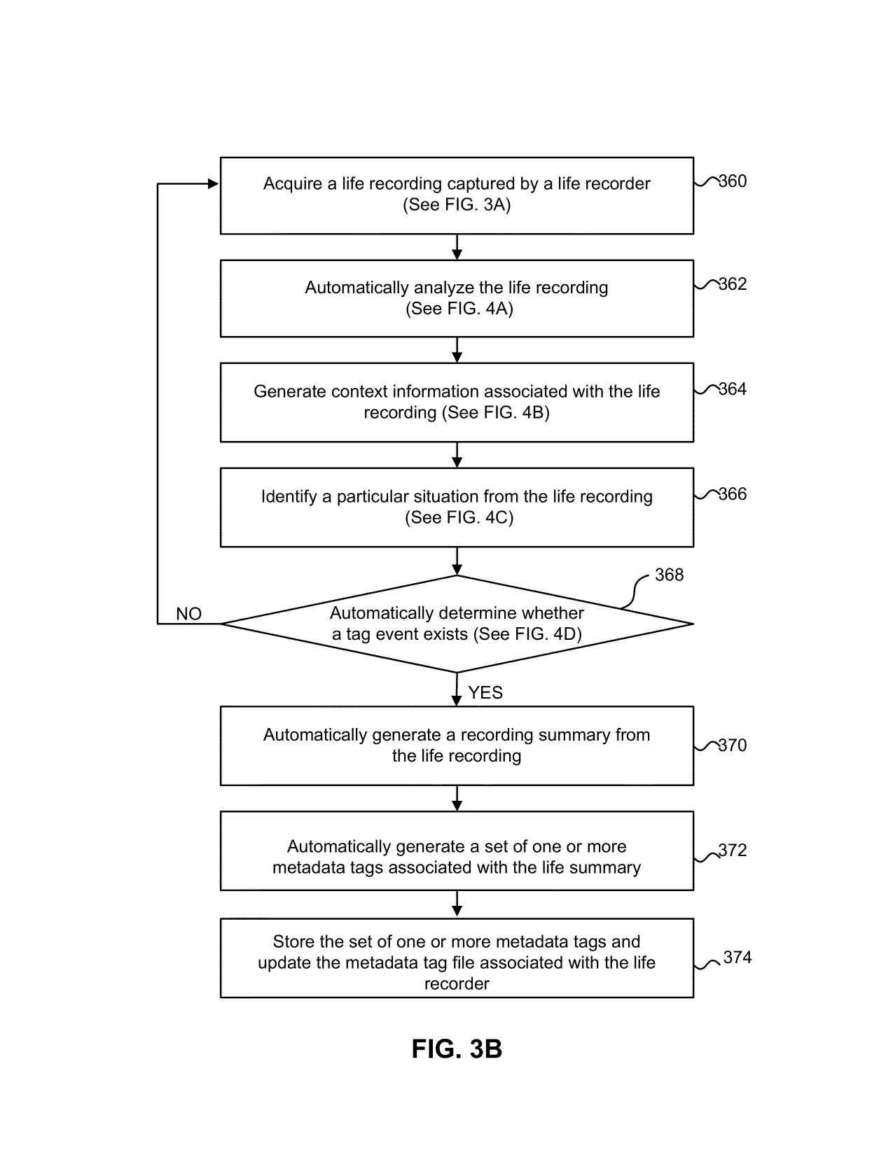

FIG. 3 is a flowchart describing one embodiment of a process according to an embodiment of the present technology. The process of FIG. 3 may be performed continuously by a life recorder. The process of FIG. 3 may be performed by one or more computing devices. Each step in the process of FIG. 3 may be performed by the same or different computing devices as those used in other steps, and each step need not necessarily be performed by a single computing device. In one embodiment, the process of FIG. 3 is performed continuously by a life recorder such as life recorder 240 in FIG. 1A.

In step 302, tasks are performed and life experiences are encountered by a user. The tasks performed and the life experiences encountered by a user may include any tasks that the user may perform and any life experiences that the user may have or encounter in a particular day of the user's life. For example, the one or more tasks performed and life experiences encountered may include the user visiting a theme park during a vacation, watching sea lions and dolphins performing, singing and dancing in front of a live audience, playing tennis with a friend, driving a car, walking the dog, washing dishes, laughing, talking, and so on.

In step 304, the tasks performed and the life as experienced by the user are recorded (captured) to acquire a life recording associated with the user. In one example, a life recorder, such as life recorder 240 of FIG. 1, may be used to acquire video and/or audio recordings related to the user's life experiences and/or other information related to the user. In another example, a capture device, such as capture device 58 in FIG. 2B, may be used to acquire video and/or audio recordings related to the user's life experiences. Step 304 will be discussed in more detail with reference to FIG. 3A.

In step 306, a set of one or more metadata tags is added to the life recording acquired in step 304. In one embodiment, a set of one or more metadata tags is automatically generated and added to the life recording based on context information associated with the life recording and/or one or more particular situations identified from the life recording. For example, a metadata tag <Greece> may be automatically generated for the life recording based on location information associated with the life recorder at the time of recording. In another example, a metadata tag <Red> may be automatically generated for the life recording when a red sport car was detected from the life recording by using object recognition techniques. Step 306 will be discussed in more detail with reference to FIG. 3B.

In step 308, the set of one or more metadata tags generated in step 306 is stored. In some embodiments, a separate metadata tag file may be created to store all the metadata tags associated with life recordings captured by a life recorder (e.g, life recorder 240 of FIG. 1A). In one embodiment, a life recorder may store the metadata tags stored locally. In another embodiment, a remote storage device (e.g., application server 250 in FIG. 1A) may be used to store the metadata tags. The metadata tags may also be stored in the cloud. Step 308 will be discussed in more detail with reference to FIG. 3B.

In step 310, one or more search criteria are provided by the user or entities associated with one or more other devices. In one embodiment, one or more search criteria are provided by the user of a life recorder (e.g., life recorder 240 of FIG. 1A) or by some other entities of one or more different life recorders via a user interface associated with the respective life recorder and the one or more different recorders to retrieve audios, videos, and/or other recordings captured by the life recorder associated with the user. In one embodiment, one or more search criteria provided in step 310 may be based on one or more keywords related to a particular event, location, time, an individual, etc. For example, one search criterion provided at step 310 may include the keyword “Paris,” while another search criterion may include a combination of keywords such as “my wife,” “Disney World,” and “Jun. 22, 2011.”

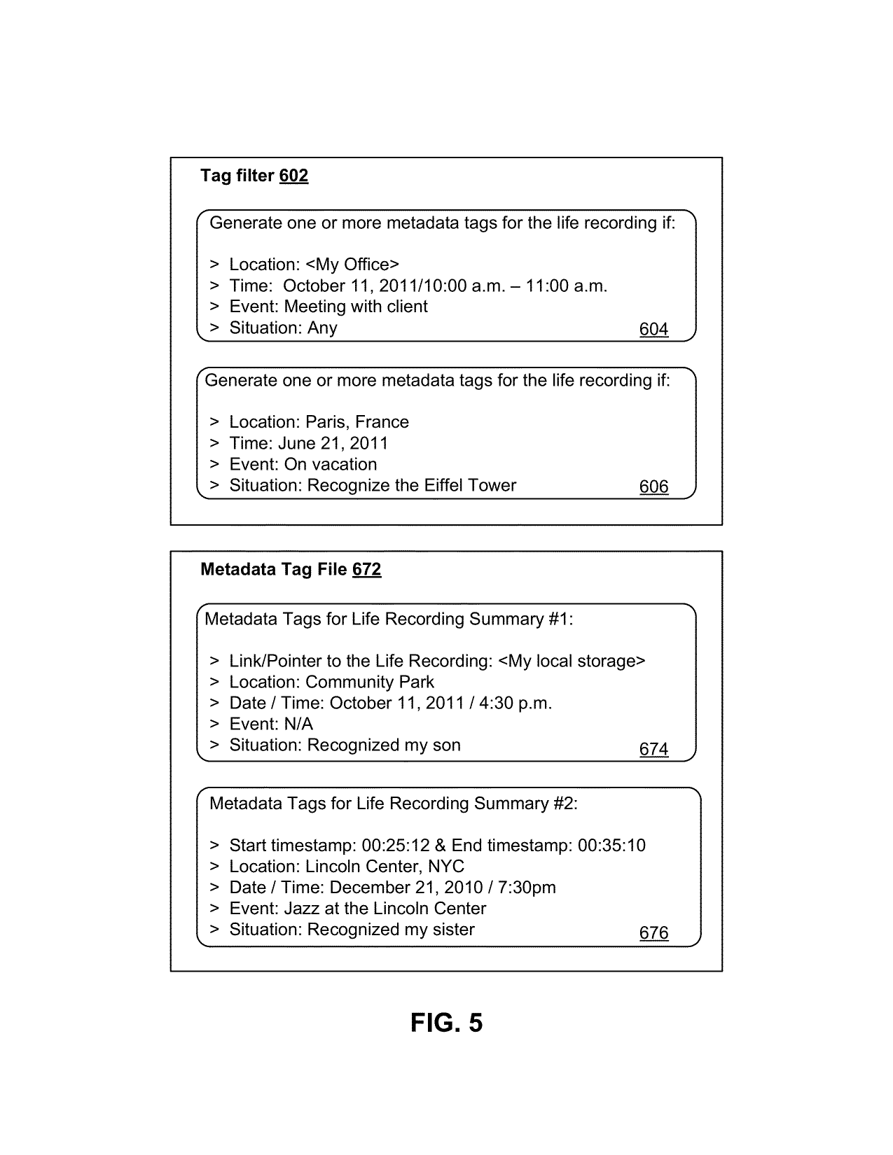

In step 312, the metadata tags are searched based on the search criteria provided in step 310. In one embodiment, the metadata tags stored in a metadata tag file may be indexed as searchable keywords for the user or entities associated with one or more other devices to efficiently retrieve audio and/or video recordings that relate to a particular event, location, time, etc. For example, a user may wish to retrieve audio and/or video recordings that relate to his various trips to a particular destination. In that case, a keyword search of the metadata tags stored in a metadata tag file may identify the audios and/or videos recordings that are described in terms of that particular destination (e.g., Disney World). In another example, a user may wish to retrieve audios and/or videos recordings that relate to a particular individual. In that case, a keyword search of the metadata tags stored in a metadata tag file may identify the audios and/or videos that are described in terms of that particular individual (e.g., my wife). Step 312 will be discussed in more detail with reference to FIG. 5.

In one embodiment, verbal communications may be extracted from the life recording acquired in step 304 as text and stored in a remote storage device (e.g., application server 250 in FIG. 1A) to be searched at a later time.

In step 314, a portion of the life recording is identified based on the search performed in step 312. For example, a keyword search of the metadata tags may identify a portion of the life recording related to a particular place (e.g., Paris, France), a particular event or situation (e.g., Meeting with Client), and/or a particular individual (e.g., my mom).

In step 316, the portion of the life recording identified in step 314 is reported to the user or other entities associated with one or more other devices providing the search criteria. In one embodiment, the portion of the life recording identified in step 314 is displayed by presenting the portion of the life recording on a display device. For example, the life recording identified in step 314 may be displayed on an LCD screen, a head mounted display of the wearer/user taking the life recording, or other retina display of the respective life recorders associated with the user and/or other entities.

FIG. 3A is a flowchart describing one embodiment of a process for acquiring a life recording associated with one or more life experiences of a user. The process of FIG. 3 may be performed continuously by a life recorder. The process of FIG. 3 may be performed by one or more computing devices. Each step in the process of FIG. 3 may be performed by the same or different computing devices as those used in other steps, and each step need not necessarily be performed by a single computing device. In one embodiment, the process of FIG. 3 is performed continuously by a life recorder such as life recorder 240 in FIG. 1A.

In step 340, digital images and/or videos related to the user's life experiences are captured. In one embodiment, a life recorder, such as life recorder 240 of FIG. 1, may be used to capture digital images and/or videos related to the user's life experiences. For example, camera 228 of life recorder 240 may capture digital images and/or videos related to the user's life experiences. In another embodiment, a capture device, such as capture device 58 in FIG. 2B, may be used to capture digital images and/or videos related to the user's life experiences.

In step 342, audios related to the user's life experiences are captured. In one embodiment, a life recorder, such as life recorder 240 of FIG. 1, may be used to capture audios related to the user's life experiences. For example, microphone 229 in life recorder 240 may capture sounds related to the user's life experiences. In another embodiment, a capture device, such as capture device 58 in FIG. 2B, may be used to capture audios related to the user's life experiences.

In step 344, human subject data associated with the user is captured. In one embodiment, a life recorder, such as life recorder 240 of FIG. 1, may be used to capture human subject data associated with the user. For example, sensors 224 in life recorder 240 may capture unique human data including biological and physiological properties associated with the user of life recorder 240 such as body temperature, heart rate, galvanic skin response, blood volume pulse, respiration, pupillary response, and the like. In another embodiment, a capture device, such as capture device 58 in FIG. 2B, may be used to capture human subject data associated with the user.

In step 346, environmental data associated with the life recording is captured. In one embodiment, a life recorder, such as life recorder 240 of FIG. 1, may be used to capture environmental data associated with the life recording. For example, sensors 224 of life recorder 240 may capture environmental data associated with the life recording such as geographic positioning using Global Positioning System (GPS), time information, weather data such as wind speed, temperature, humidity, detection of smoke, flames, traffic speed and direction, and so on. In another embodiment, a capture device, such as capture device 58 in FIG. 2B, may be used to capture environmental data associated with the life recording.

In step 348, the information and/or data captured in steps 340-346 are stored. In some embodiments, once a life recording has been acquired, the life recording or a portion of the life recording may be buffered to facilitate analysis of the life recording. For example, the last two minutes of a particular life recording may be stored in a memory buffer for analysis. In one embodiment, video and/or audio recordings captured by a life recorder over a particular period of time (e.g., 30 minutes) may be placed into a memory buffer. In the case of a cyclic buffer, if the video and/or audio recordings are not analyzed and/or stored elsewhere within the particular period of time, then the data associated with the video and/or audio recordings may be overwritten.

FIG. 3B is a flowchart describing one embodiment of a process for adding a set of one or more metadata tags to a life recording. The process of FIG. 3B may be performed continuously by a life recorder. The process of FIG. 3B may be performed by one or more computing devices. Each step in the process of FIG. 3B may be performed by the same or different computing devices as those used in other steps, and each step need not necessarily be performed by a single computing device. In one embodiment, the process of FIG. 3B is performed continuously by a life recorder such as life recorder 240 in FIG. 1A.

In step 360, a life recording captured by a life recorder is acquired. In one example, a life recorder, such as life recorder 240 of FIG. 1, may be used to acquire video and/or audio recordings related to a user's life experiences and/or other information related to the user. In another example, a capture device, such as capture device 58 in FIG. 2B, may be used to acquire video and/or audio recordings related to a user's life experiences. Step 360 are discussed in more detail with reference to FIG. 3A.

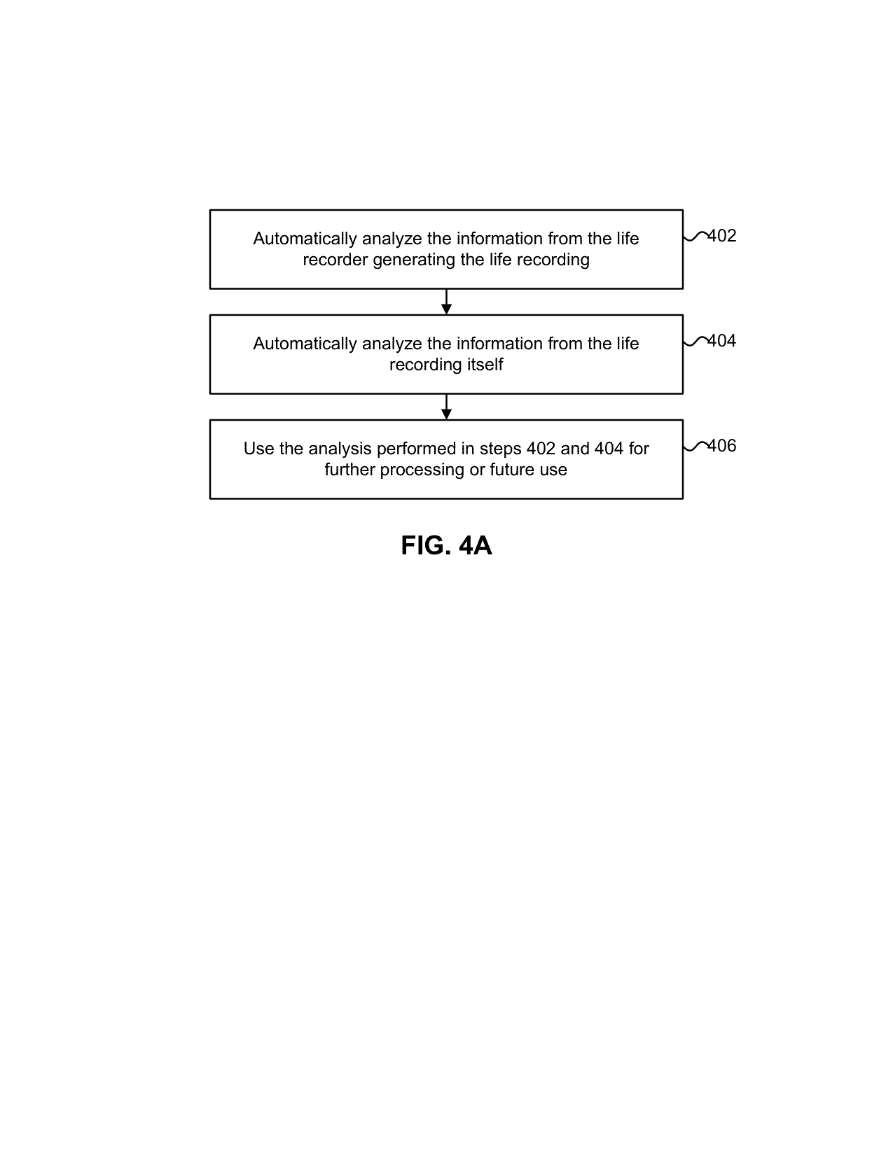

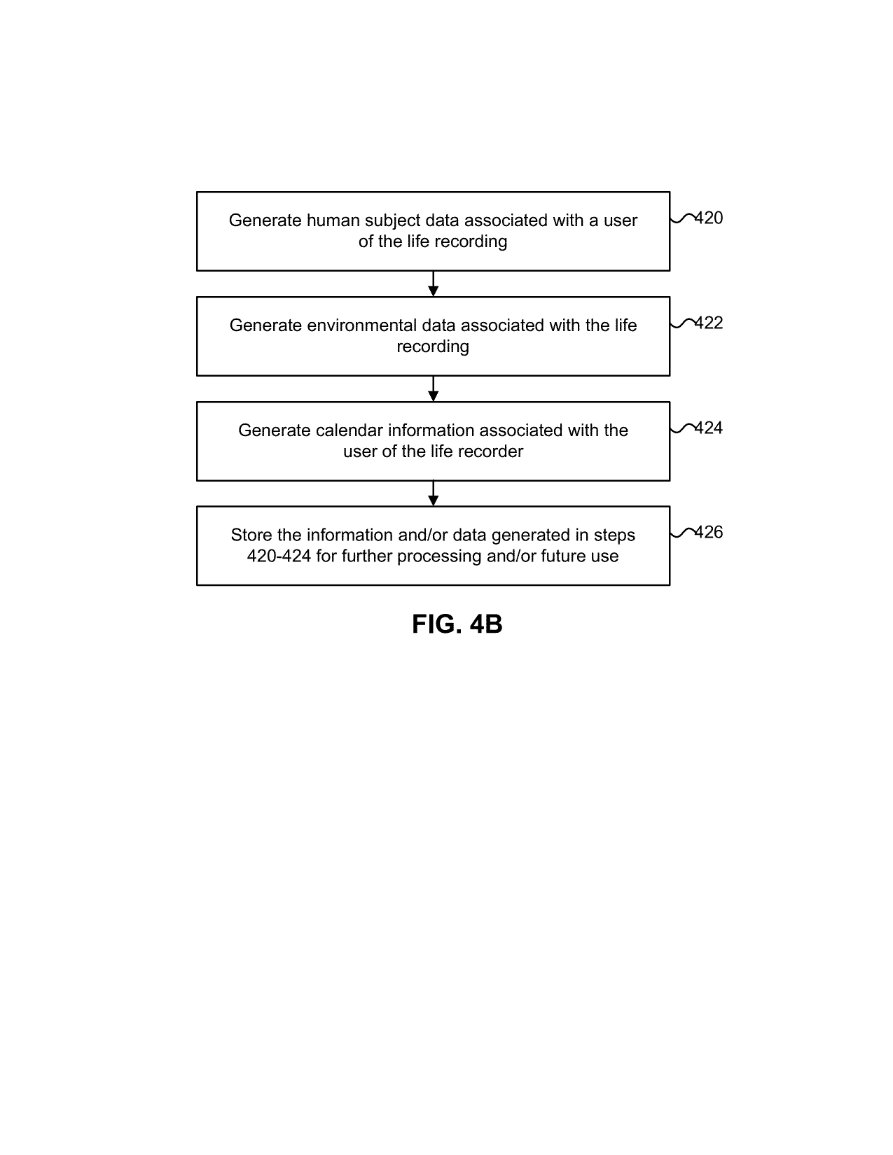

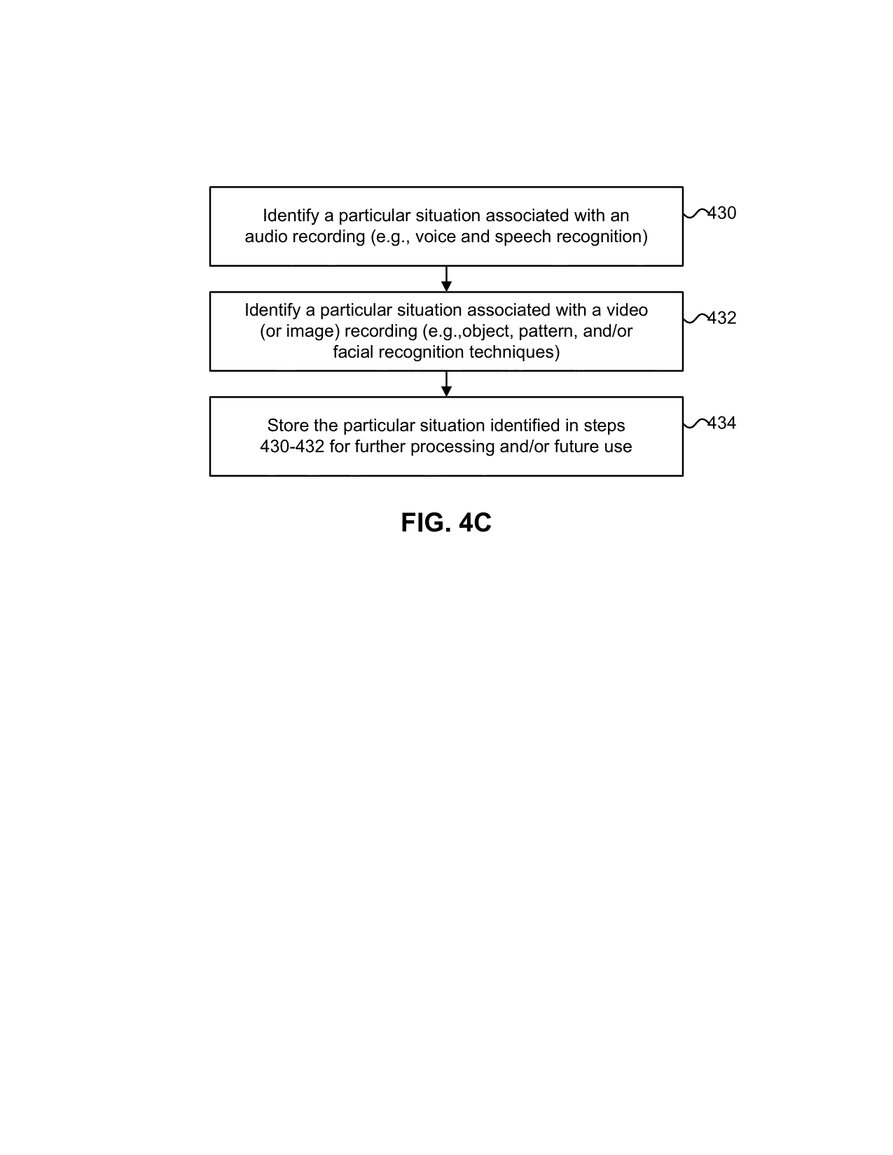

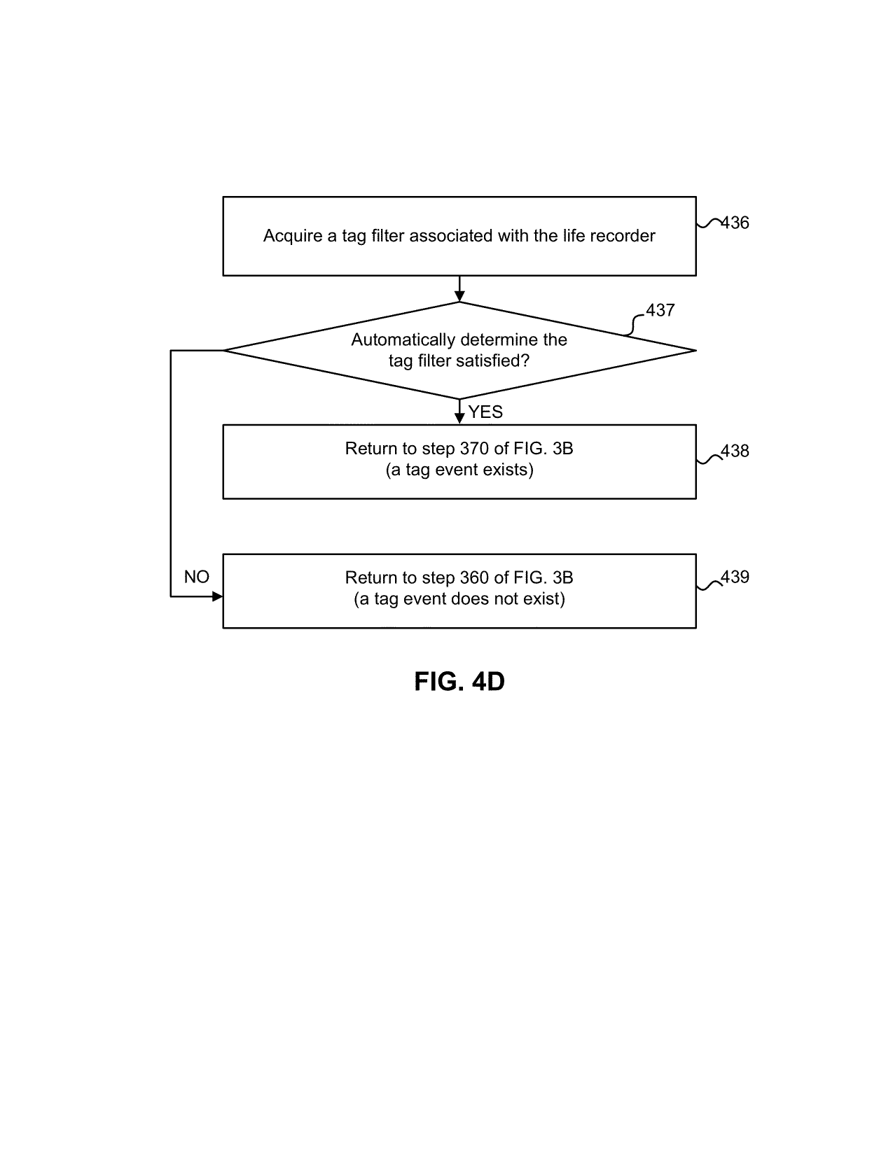

In step 362, the life recording captured by the life recorder is automatically analyzed. In one embodiment, a life recorder, such as life recorder 240 of FIG. 1, may automatically analyze the life recording captured by the life recorder. For example, processor 226 of life recorder 240 allows life recorder 240 to execute computer readable instructions stored in memory 227 to perform the analysis discussed herein. In another example, a life recorder, such as life recorder 50 of FIG. 2B, may process video, audio, and other data received from capture device 58 by analyzing the video, audio, and other data received to detect and/or track an event, an object, and/or an individual. Step 362 are discussed in more detail with reference to FIG. 4A.

While the life recording or a portion of the life recording is being analyzed, the life recorder may continue to capture new life experiences. In one embodiment, analysis in step 362 may be performed in real-time (e.g., as the life recording is being captured), at regular time intervals (e.g., every 30 seconds), upon a triggering event associated with the life recording (e.g., the user of the life recorder pushes a button), or offline (e.g., after the life recording has been captured). In one embodiment, analysis of the life recording captured by the life recorder may be performed manually (e.g., by a human “librarian”).

In step 364, context information associated with the life recording is generated. In one embodiment, context information may include unique human subject data associated with the user, environmental data associated with the life recording, and/or calendar information associated with the user of the life recorder. In one embodiment, context information may be generated by the life recorder itself via one or more integrated sensors. Step 364 are discussed in more detail with reference to FIG. 4B.

In step 366, a particular situation from the life recording is identified. A particular situation may be identified from a video recording and/or an audio recording captured by the life recorder using various techniques such as voice and speech recognition, eye tracking for gaze detection, object, pattern, and/or facial recognition techniques. Step 366 are discussed in more detail with reference to FIG. 4B.

In step 368, it is automatically determined whether a tag event exists. In some embodiments, a tag event is deemed to exist if a tag filter associated with the life recorder is satisfied by the context information identified in step 364 and/or one or more particular situations identified in step 366. Step 368 will be discussed in more detail with reference to FIG. 4D.

If a tag event exists, then steps 370 to 374 are performed as discussed below. If a tag event does not exist, then processing return to step 360 such that steps 360 to 368 are performed in order to continuously check for the emergence of one or more tag events associated with newly captured life experiences. In one embodiment, regardless of whether a tag event is detected or not, the life recorder may continuously perform steps 360 to 368 in order to continuously check for the emergence of one or more tag events associated with newly captured life experiences.

In some embodiments, rather than a life recorder automatically determining the existence of a tag event, the tag event may be determined manually by a user of the life recorder. For example, when a user wishes to tag a life recording or a portion of the life recording with one or more metadata tags, the user may physically push a button located on the life recorder or issue a specific voice command to the life recorder. Upon detection of the user's manual directive, the life recorder may automatically generate a set of one or more metadata tags for the life recording.

In step 370, a recording summary is automatically generated from the life recording. In one embodiment, a recording summary may comprise a portion of the life recording that is associated with the time duration during which a set of requirements in a tag filter is satisfied (See FIG. 4D). In another embodiment, a recording summary may comprise a portion of the life recording that is associated with the time duration for which a particular situation and/or event were identified. For example, referring to FIG. 1C, a particular situation involving the appearance of a dog captured by capture device 20 for a time duration of two minutes was identified, then a recording summary is generated that may include the two minute video and audio recordings associated with the appearance of the dog captured by capture device 20.

In one embodiment, the recording summary generated in step 370 is stored. The recording summary may be stored locally in a non-volatile memory on a life recorder or remotely on a remote storage server, such as application server 250 in FIG. 1A. The recording summary may also be stored in the cloud.

In step 372, a set of one or more metadata tags is automatically generated for the recording summary generated in step 370. In one embodiment, a set of one or more metadata tags is automatically generated for the recording summary based on the context information identified in step 364 and/or the one or more particular situations identified in step 366. For example, a metadata tag <Greece> may be automatically generated for the recording summary based on the location information associated with the life recorder at the time of recording. Optionally, a metadata tag generated based on the location information associated with the life recorder may also include geo-coordinates such as longitude of <2.33739> and latitude of <48.89364>. In another example, a metadata tag <Red> may be automatically generated for the recording summary when a red sport car was detected from the recording summary by using object recognition techniques. In yet another example, a metadata tag <My Wife> may be automatically generated for the recording summary when my wife's voice was detected from the recording summary by using voice recognition techniques. In a further example, a metadata tag <Happy> may be automatically generated for the recording summary when a person's facial expression suggesting extreme happiness was detected from the recording summary by using facial recognition techniques. Below are some example rule format that may be used for generating a set of one or more metadata tags for the life recording captured by the life recorder:

### EXAMPLE #1

IF “Location (<My Home>) AND Time (<Any>) AND Event (<Any>) AND Situation (<My wife>);” THEN “Metadata_tag_{—}#1=home; Metadata_tag_{—}#2=wife”

### EXAMPLE #2

IF “Location (<Disney World>) AND Time (<Jun. 22, 2011>) AND Event (<Any>) AND Situation (<Recognize Mickey Mouse>),” THEN “Metadata_tag_{—}#1=Disney_Orlando; Metadata_tag_{—}#2=Mickey; Metadata_tag_{—}#3=Vacation 2011”

In some embodiments, rather than a life recorder automatically generating a set of one or more metadata tags for the recording summary, the metadata tags may be generated manually by a user of the life recorder or by another individual. For example, when a user wishes to tag a life recording or a portion of the life recording with a set of one or more metadata tags, the user may manually enter one or more metadata tags for the life recording using an input device (e.g., keyboard) via a user interface.

In step 374, the set of one or more metadata tags generated in step 372 is stored and a separate metadata tag file associated with the life recorder is updated. In one embodiment, a separate metadata tag file may be created to store all the metadata tags associated with the life recording captured by the life recorder. An index or cross-reference may be used to correlate each set of metadata tags with a corresponding recording summary for which the set of metadata tags was generated. In one embodiment, for each set of metadata tags generated in step 372, the metadata tag file may store the set of metadata tags generated for the recording summary along with a pointer or link to the corresponding recording summary. As such, the metadata tag file need not contain the actual video and/or audio recordings pointed to. In another embodiment, for each set of metadata tags generated in step 372, the metadata tag file may store the set of metadata tags generated for the recording summary along with a start time stamp and an end time stamp associated with the recording summary indicating a particular time duration in the life recording when a particular situation was identified (e.g., a recording summary may comprise a portion of the life recording starting from 13 minutes and 25 seconds and ending at 25 minutes and 10 seconds during which a particular situation was identified from the life recording). These time stamps associated with the recording summary allow the metadata tags stored in the metadata file to remain time synchronized with the life recording captured by the life recorder.

In one embodiment, a life recorder may store a metadata tag file locally and update the metadata tag file every time a set of one or more new metadata tags is generated and stored for a recording summary generated by the life recorder. In another embodiment, a remote storage device (e.g., application server 250 in FIG. 1A) may be used to store and update the metadata tag file associated with the life recorder. The metadata tag file may also be stored in the cloud.

In some embodiments, a metadata tag file associated with a life recorder may be shared by other entities or users of one or more different computing devices. For example, referring to FIG. 1A, application server 250 receives a set of one or more metadata tags generated for a recording summary from life recorder 240, updates the metadata tag file associated with life recorder 240, and transmits the metadata tag file associated with life recorder 240 to mobile device 210. Mobile device 210 may subsequently search the metadata tag file associated with life recorder 240 to find and/or download a particular life recording of interest from application server 250.

FIG. 4A is a flowchart describing one embodiment of a process for automatically analyzing a life recording. The processes described in FIG. 4A are only examples of processes for implementing step 362 in FIG. 3B. The process of FIG. 4A may be performed by one or more computing devices. Each step in the process of FIG. 4A may be performed by the same or different computing devices as those used in other steps, and each step need not necessarily be performed by a single computing device. In one embodiment, the process of FIG. 4A is performed continuously by a life recorder such as life recorder 240 in FIG. 1A.

In step 402, information from the life recorder generating the life recording is automatically analyzed. In one embodiment, information from the life recorder generating the life recording may include information associated with the life recorder but not necessarily acquired from the life recording itself, e.g., the GPS location of the life recorder, the date and time of the life recording, the start and end times associated with the life recording, and the like. In one embodiment, information from the life recorder generating the life recording may be analyzed to determine context information (e.g., location information and time information) associated with the life recording and/or whether a particular condition or situation has occurred. For example, information obtained from an integrated GPS device may be analyzed to determine the location information of the life recorder at the time of the life recording. In another example, the location information of the life recorder may be determined based on information obtained from one or more cell towers, co-location from another computing system, one or more landmarks recognized, and/or known map data identified.

In step 404, information from the life recording itself may be automatically analyzed. In one embodiment, the analysis of the life recording may take into consideration context information associated with the life recording, e.g., the GPS location of the life recorder, the date of a life recording, the start and end times associated with the life recording, etc. Various techniques may be used to analyze information from the life recording to determine whether a particular condition or situation has occurred. For example, voice recognition may be used to analyze information from the life recording to identify the voice of a particular person (e.g., a spouse) or to identify a particular phrase or comment (e.g., a phrase used in an emergency situation such as a call for help). In another example, object, pattern, facial, and/or facial recognition techniques may be used to analyze information from the life recording to identify a particular object (e.g., a soccer ball) and/or a particular person (e.g., a friend).

In step 406, the analysis performed in steps 402 and 404 may be used for further processing. For example, the analysis performed in steps 402 and 406 may be used to generate context information associated with the life recording may be generated in step 364 of FIG. 3B.

FIG. 4B is a flowchart describing one embodiment of a process for automatically generating context information for a life recording. The processes described in FIG. 4B are only examples of processes for implementing step 364 in FIG. 3B. The process of FIG. 4B may be performed by one or more computing devices. Each step in the process of FIG. 4B may be performed by the same or different computing devices as those used in other steps, and each step need not necessarily be performed by a single computing device. In one embodiment, the process of FIG. 4B is performed continuously by a life recorder such as life recorder 240 in FIG. 1A.

In step 420, human subject data associated with the user is generated. In one embodiment, human subject matter may be generated by the life recorder via one or more integrated sensors. For example, human subject matter may be generated by sensors 224 in life recorder 240 associated with the user. Human subject data may include biological and physiological properties associated with the user of the life recorder such as body temperature, heart rate, galvanic skin response, blood volume pulse, respiration, pupillary response, and so on.

In step 422, environmental data associated with the life recording is generated. In one embodiment, environmental data associated with the life recording may include information associated with the life recording at the time of recording such as location and time information associated with the life recording, weather data such as wind speed, temperature, humidity, detection of smoke, flames, traffic speed and direction, and so on. In one embodiment, environmental data associated with the life recording may be generated by the life recorder via one or more integrated sensors. For example, location information such as GPS coordinates or other identification of a particular geographical location associated with the life recorder at the time of recording may be generated by the life recorder itself via an integrated GPS device, while time information such as the particular date and time (e.g., a timestamp) associated with the life recorder at the time of recording may be generated by the life recorder itself via a time keeping device. The time information may also be obtained via the cloud. The location information of the life recorder may also be obtained based on information from one or more cell towers, co-location from another computing system or device, one or more landmarks recognized, and/or known map data identified.

In step 424, calendar information associated with the user of the life recorder is generated. The calendar information may include a description of the calendar event associated with the time of recording by the life recorder. In one example, at the time of recording a life recording, it may be determined that the time of recording is Jan. 11, 2011 at 2:05 p.m., the location of the life recorder is a particular GPS location, and the calendar information comprises the description “Meeting with client.”

In step 426, the information and/or data generated in steps 420-424 may be stored for further processing and/or future use. For example, the context information generated in steps 420-424 may be used to determine whether a tag event exists according to step 368 of FIG. 3B. In one embodiment, the context information generated in steps 420-424 may be stored locally in the life recorder itself or in a remote storage device (e.g., application server 250 of FIG. 1A).

FIG. 4C is a flowchart describing one embodiment of a process for automatically analyzing a life recording. The processes described in FIG. 4C are only examples of processes for implementing step 366 in FIG. 3B. The process of FIG. 4C may be performed by one or more computing devices. Each step in the process of FIG. 4C may be performed by the same or different computing devices as those used in other steps, and each step need not necessarily be performed by a single computing device. In one embodiment, the process of FIG. 4C is performed continuously by a life recorder such as life recorder 240 in FIG. 1A.

In step 430, a particular situation associated with an audio recording may be identified. In one embodiment, a particular situation associated with an audio recording may be identified using voice recognition techniques. For example, voice recognition may be used to identify the voice of a particular person (e.g., a spouse) or to identify a particular phrase or comment (e.g., a phrase used in an emergency situation such as a call for help). The particular situation may also be identified from an audio recording by detecting significant changes in the pitch of a person's voice or detecting sounds associated with particular human actions such as crying, gasping, or heavy breathing.

In step 432, a particular situation associated with a video (or image) recording may be identified. In one embodiment, a particular situation associated with a video (or image) recording may be identified using object, pattern, and/or facial recognition techniques. For example, facial recognition may be used to identify a particular person and object recognition may be used to identify a particular object within a portion of a video recording. In one example, the particular situation identified may include detecting of a particular object (e.g., a soccer ball) and a particular person (e.g., a friend). In another example, the particular situation identified may include a particular gesture (e.g., waiving) being performed by the particular person. In yet another example, the particular situation identified may include detecting of a particular emotion (e.g., fear) associated with the particular person using techniques of facial recognition, voice recognition, speech recognition, gaze detection, biometric responses, and the like. The particular situation may also be identified using machine learning techniques that employ probabilistic and/or statistical analyses to detect one or more targets and/or objects. The machine learning techniques may learn to detect particular targets and/or objects from analyzing a training set of the particular targets and/or objects. More information about applying machine learning techniques to detect targets and/or objects in image and video recordings may be found in U.S. patent application Ser. No. 12/972,837, “Detection of Body and Props” filed Dec. 20, 2010, incorporated herein by reference in its entirety.

In step 434, the particular situation identified in steps 430-432 may be stored for further processing and/or future use. For example, a particular situation identified from a video recording may be used to determine whether a tag event exists according to step 368 of FIG. 3B. In one embodiment, the particular situation identified in steps 430-432 may be stored locally in the life recorder itself or in a remote storage device (e.g., application server 250 of FIG. 1A).

FIG. 4D is a flow chart describing embodiments of a process for automatically detecting whether a tag event exists. The processes described in FIG. 4D are only examples of processes for implementing step 368 in FIG. 3B. The processes of FIG. 4D may be performed by one or more computing devices. Each step in the processes may be performed by the same or different computing devices as those used in other steps, and each step need not necessarily be performed by a single computing device. The processes of FIG. 4D may be performed by a life recorder such as life recorder 240 in FIG. 1A.

Referring to FIG. 4D, In step 436, a tag filter associated with a life recorder is acquired. The tag filter may include one or more rules (or requirements) for determining when to generate a set of one or more metadata tags for the life recording captured by the life recorder. If the one or more rules for determining when to generate a set of one or more metadata tags for the life recording captured by the life recorder have already been acquired, then step 436 may be omitted.

In step 437, it is determined whether the tag filter is satisfied. In some embodiment, a tag filter may be satisfied if any of the set of requirements contained within the tag filter are satisfied by the context information and particular situation identified in steps 406 and 408 of FIG. 3. If the tag filter is satisfied, then step 438 is performed by returning to step 370 of FIG. 3B. If the tag filter is not satisfied, then step 439 is performed by returning to step 360 of FIG. 3B.

FIG. 5 depicts one embodiment of a tag filter 602 and a metadata tag file 672. Tag filter 602 includes a first set of requirements 604 and a second set of requirements 606. Each of first set of requirements 604 and second set of requirements 606 determines when a set of one or more metadata tags will be generated for the life recordings captured by the life recorder. Although tag filter 602 as shown in FIG. 5 includes only first set of requirements 604 and second set of requirements 606, tag filter 602 may include additional sets of requirements.

Both first set of requirements 604 and second set of requirements 606 include fields for location, time, event, and situation. When all the fields in a set of requirements are satisfied, then the set of requirements is deemed to be satisfied. The location field corresponds with the geographical location for the life recording. For example, the location field for first set of requirements 604 is assigned to a GPS location associated with the term “<My Office>,” while the location field for second set of requirements 606 is assigned to a GPS location associated with Paris, France. The time field corresponds to the time of the life recording. For example, the time field for first set of requirements 604 may be satisfied between the hours of 10:00 a.m. and 11:00 a.m. on Oct. 11, 2011, while the time filed for second set of requirements 606 may be satisfied anytime on Jun. 21, 2011. The event field corresponds with calendar information associated with a user of the life recorder. For example, the event field for first set of requirements 604 may be satisfied if calendar information associated with the user of the life recorder specifies that the user is meeting with client, while the event field for second set of requirements 606 may only be satisfied if calendar information associated with the user of the life recorder specifies that the user is on vacation. The situation field corresponds with a particular situation that must be recognized or detected before one or more metadata tags are generated for the life recording captured by the life recorder. For example, the situation field for first set of requirements 604 may be satisfied by any situation, while the situation field for second set of requirements 606 may be satisfied only if the Eiffel Tower is recognized.

Metadata tag file 672 includes index entry 674 corresponding to a set of metadata tags associated with a first recording summary and index entry 676 corresponding to a set of metadata tags associated with a second recording summary. Both entry 674 and entry 676 include searchable metadata tags related to location, time, event, and situation. For example, a metadata tag for the location field corresponds with the geographical location for the life recording, a metadata tag for the time field corresponds to the time of the life recording, a metadata tag for the event field corresponds with calendar information associated with a user of the life recorder (e.g., Jazz at the Lincoln Center), a metadata tag for the situation field corresponds with a particular situation recognized or detected from the life recording captured by the life recorder (e.g., my son is recognized or detected from the life recording).

Each index entry in metadata tag file 672 may be searched or queried based on one or more search criteria to enable a user of the life recorder (e.g., life recorder 240 of FIG. 1) or some other entities or users of one or more different life recorders to efficiently retrieve audios, videos, and/or other recordings captured by the particular life recorder. In one embodiment, the metadata tags stored in metadata tag file 672 may be indexed (e.g., index entry 674 and index entry 676) as searchable keywords to enable a user to efficiently retrieve audio and video recordings that relate to a particular event, location, time, etc. For example, a user may wish to retrieve all recordings that relate to his various trips to a particular destination. In that case, a keyword search of the metadata tags stored in a metadata tag file would identify all the audios, videos and/or other recordings that are described in terms of that particular destination (e.g., Paris, France). In another example, a user may wish to retrieve all recordings that relate to his meeting with a particular individual. In that case, a keyword search of the metadata tags stored in a metadata tag file would identify all the audios, videos and/or other recordings that are described in terms of that particular event or situation (e.g., Meeting with Client or my sister is recognized). In yet another example, a user of a life recorder may search the metadata tag file associated with a different life recorder to find related recordings captured by the particular life recorder on the same day at the same event. This would enable the user to compare his recordings with those captured by others who have participated in that same event. As will be appreciated, there are many useful applications of this technology.

During a search of one or more entries in metadata tag file 672, if one or more fields in an entry are satisfied, then that entry may be deemed to be satisfied. For example, once an index entry has been satisfied, then a corresponding recording may be found and downloaded from a location referenced by the “link/pointer to the life recording” field, e.g., “<My local storage>” as specified in index entry 674. Alternatively, once a search has been found, then the portion of the life recording corresponding with the Start timestamp and the End timestamp, e.g., Start timestamp: 00:25:12 & End timestamp: 00:35:10 as specified in index entry 676, may be found and downloaded from the life recording. In other words, the portion of the life recording captured by the life recorder starting from 25 minutes and 12 seconds and ending at 35 minutes and 10 seconds is found and downloaded.

In one embodiment, search of a metadata tag file may be carried out in real-time (e.g., when the life recording is being captured) or upon a triggering event. For example, when a user wishes to search for a particular life recording captured by a life recorder, the user may physically push a button located on the life recorder or issue a specific voice command to the life recorder. Upon detection of the user's manual directive, the life recorder may automatically activate a search of the metadata tag file associated with the life recorder. In one embodiment, eye tracking may be used to detect whether a user of a life recorder has indicated an item of interest or requested for more information related to a particular situation or event. For example, upon detection of the user's indication of interest based on the eye tracking result, the life recorder may automatically activate a search of the metadata tag file associated with the life recorder. A metadata tag file may also be searched manually such as by a human “librarian”. In one embodiment, a user is given an option to either perform a “free” metadata search at no cost or to upgrade to a micro-payment based search by using a human “librarian.”

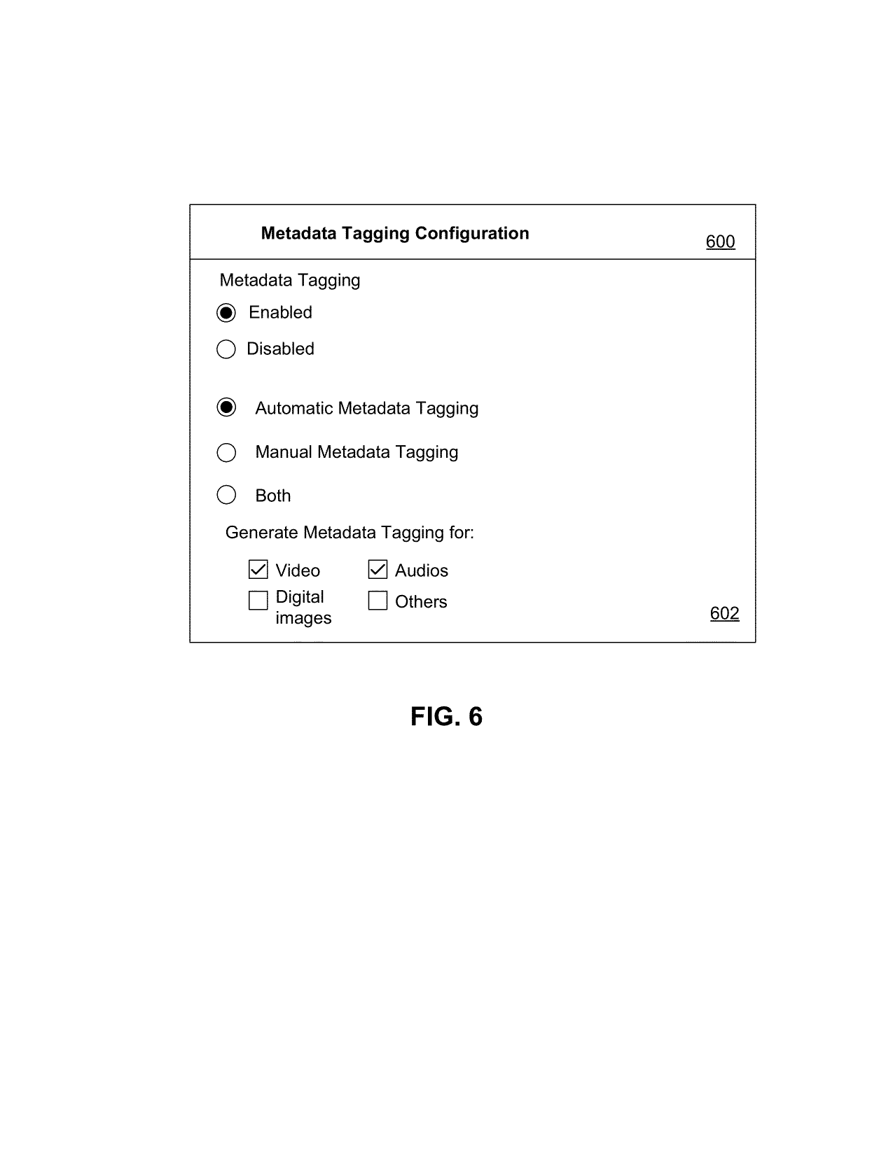

FIG. 6 depicts one embodiment of a metadata tagging configuration 600 for a user to configure various settings and preferences 602 related to metadata tagging for life recordings captured by a life recorder. In one embodiment, metadata tagging may be enabled or disabled, and the manner in which the metadata tags are generated may be controlled (e.g., automatic and/or manual). In one embodiment, a set of metadata tags may be generated only for certain types of data, e.g., audio recording data, video recording data, or digital image data.

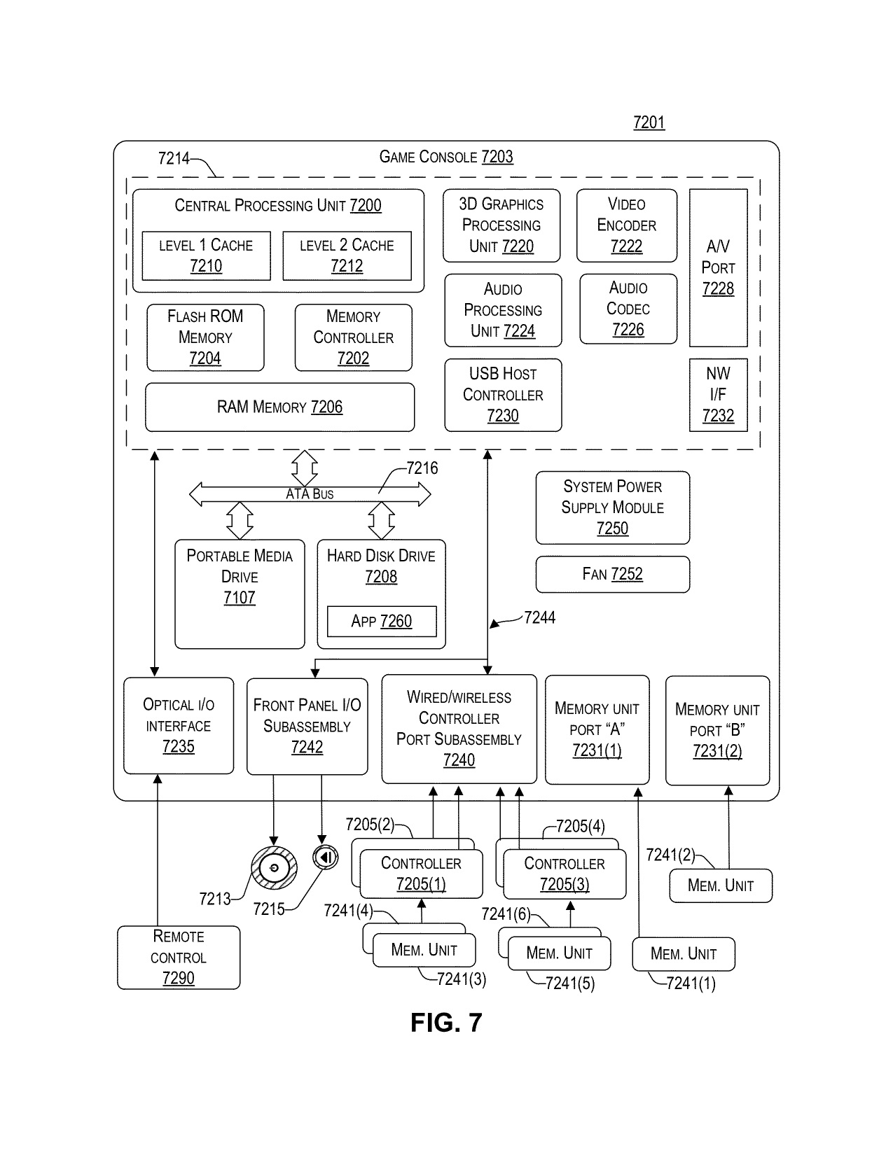

The disclosed technology may be used with various computing systems. FIGS. 7-9 provide examples of various computing systems that can be used to implement embodiments of the disclosed technology.

FIG. 7 is a block diagram of an embodiment of a gaming and media system 7201. Console 7203 has a central processing unit (CPU) 7200, and a memory controller 7202 that facilitates processor access to various types of memory, including a flash Read Only Memory (ROM) 7204, a Random Access Memory (RAM) 7206, a hard disk drive 7208, and portable media drive 7107. In one implementation, CPU 7200 includes a level 1 cache 7210 and a level 2 cache 7212, to temporarily store data and hence reduce the number of memory access cycles made to the hard drive 7208, thereby improving processing speed and throughput.

CPU 7200, memory controller 7202, and various memory devices are interconnected via one or more buses (not shown). The one or more buses might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus.

In one implementation, CPU 7200, memory controller 7202, ROM 7204, and RAM 7206 are integrated onto a common module 7214. In this implementation, ROM 7204 is configured as a flash ROM that is connected to memory controller 7202 via a PCI bus and a ROM bus (neither of which are shown). RAM 7206 is configured as multiple Double Data Rate Synchronous Dynamic RAM (DDR SDRAM) modules that are independently controlled by memory controller 7202 via separate buses (not shown). Hard disk drive 7208 and portable media drive 7107 are shown connected to the memory controller 7202 via the PCI bus and an AT Attachment (ATA) bus 7216. However, in other implementations, dedicated data bus structures of different types may also be applied in the alternative.

A three-dimensional graphics processing unit 7220 and a video encoder 7222 form a video processing pipeline for high speed and high resolution (e.g., High Definition) graphics processing. Data are carried from graphics processing unit 7220 to video encoder 7222 via a digital video bus (not shown). An audio processing unit 7224 and an audio codec (coder/decoder) 7226 form a corresponding audio processing pipeline for multi-channel audio processing of various digital audio formats. Audio data are carried between audio processing unit 7224 and audio codec 7226 via a communication link (not shown). The video and audio processing pipelines output data to an A/V (audio/video) port 7228 for transmission to a television or other display. In the illustrated implementation, video and audio processing components 7220-7228 are mounted on module 7214.

FIG. 7 shows module 7214 including a USB host controller 7230 and a network interface 7232. USB host controller 7230 is in communication with CPU 7200 and memory controller 7202 via a bus (not shown) and serves as host for peripheral controllers 7205(1)-7205(4). Network interface 7232 provides access to a network (e.g., Internet, home network, etc.) and may be any of a wide variety of various wire or wireless interface components including an Ethernet card, a modem, a wireless access card, a Bluetooth® module, a cable modem, and the like.

In the implementation depicted in FIG. 7, console 7203 includes a controller support subassembly 7240 for supporting four controllers 7205(1)-7205(4). The controller support subassembly 7240 includes any hardware and software components needed to support wired and wireless operation with an external control device, such as for example, a media and game controller. A front panel I/O subassembly 7242 supports the multiple functionalities of power button 7213, the eject button 7215, as well as any LEDs (light emitting diodes) or other indicators exposed on the outer surface of console 7203. Subassemblies 7240 and 7242 are in communication with module 7214 via one or more cable assemblies 7244. In other implementations, console 7203 can include additional controller subassemblies. The illustrated implementation also shows an optical I/O interface 7235 that is configured to send and receive signals (e.g., from remote control 7290) that can be communicated to module 7214.

MUs 7241(1) and 7241(2) are illustrated as being connectable to MU ports “A” 7231(1) and “B” 7231(2) respectively. Additional MUs (e.g., MUs 7241(3)-7241(6)) are illustrated as being connectable to controllers 7205(1) and 7205(3), i.e., two MUs for each controller. Controllers 7205(2) and 7205(4) can also be configured to receive MUs (not shown). Each MU 7241 offers additional storage on which games, game parameters, and other data may be stored. Additional memory devices, such as portable USB devices, can be used in place of the MUs. In some implementations, the other data can include any of a digital game component, an executable gaming application, an instruction set for expanding a gaming application, and a media file. When inserted into console 7203 or a controller, MU 7241 can be accessed by memory controller 7202. A system power supply module 7250 provides power to the components of gaming system 7201. A fan 7252 cools the circuitry within console 7203.

An application 7260 comprising machine instructions is stored on hard disk drive 7208. When console 7203 is powered on, various portions of application 7260 are loaded into RAM 7206, and/or caches 7210 and 7212, for execution on CPU 7200. Other applications may also be stored on hard disk drive 7208 for execution on CPU 7200.

Gaming and media system 7201 may be operated as a standalone system by simply connecting the system to a monitor, a television, a video projector, or other display device. In this standalone mode, gaming and media system 7201 enables one or more players to play games or enjoy digital media (e.g., by watching movies or listening to music). However, with the integration of broadband connectivity made available through network interface 7232, gaming and media system 7201 may further be operated as a participant in a larger network gaming community.

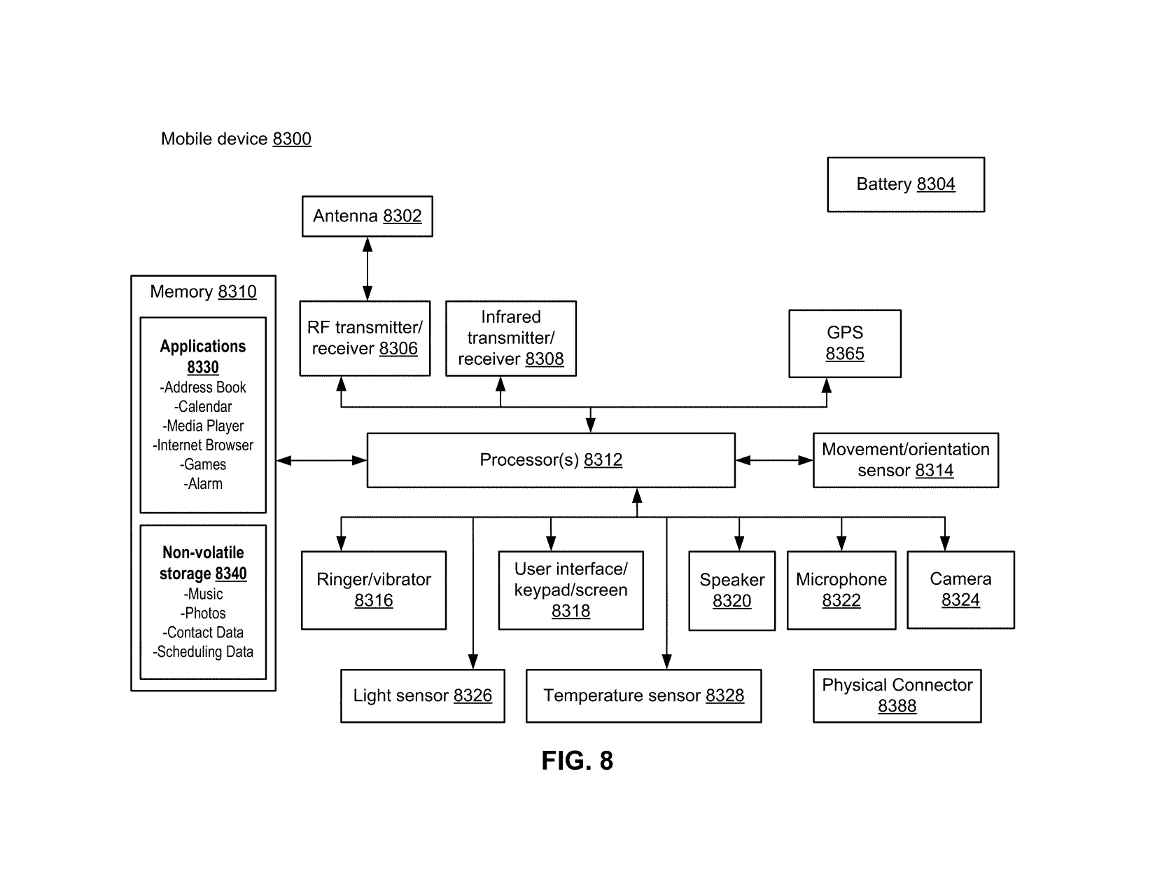

FIG. 8 is a block diagram of one embodiment of a mobile device 8300. Mobile devices may include laptop computers, pocket computers, mobile phones, personal digital assistants, and handheld media devices that have been integrated with wireless receiver/transmitter technology.

Mobile device 8300 includes one or more processors 8312 and memory 8310. Memory 8310 includes applications 8330 and non-volatile storage 8340. Memory 8310 can be any variety of memory storage media types, including non-volatile and volatile memory. A mobile device operating system handles the different operations of the mobile device 8300 and may contain user interfaces for operations, such as placing and receiving phone calls, text messaging, checking voicemail, and the like. The applications 8330 can be any assortment of programs, such as a camera application for photos and/or videos, an address book, a calendar application, a media player, an internet browser, games, an alarm application, and other applications. The non-volatile storage component 8340 in memory 8310 may contain data such as music, photos, contact data, scheduling data, and other files.

The one or more processors 8312 also communicates with RF transmitter/receiver 8306 which in turn is coupled to an antenna 8302, with infrared transmitter/receiver 8308, with global positioning service (GPS) receiver 8365, and with movement/orientation sensor 8314 which may include an accelerometer and/or magnetometer. RF transmitter/receiver 8308 may enable wireless communication via various wireless technology standards such as Bluetooth® or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 8312 further communicate with a ringer/vibrator 8316, a user interface keypad/screen 8318, a speaker 8320, a microphone 8322, a camera 8324, a light sensor 8326, and a temperature sensor 8328. The user interface keypad/screen may include a touch-sensitive screen display.

The one or more processors 8312 controls transmission and reception of wireless signals. During a transmission mode, the one or more processors 8312 provide voice signals from microphone 8322, or other data signals, to the RF transmitter/receiver 8306. The transmitter/receiver 8306 transmits the signals through the antenna 8302. The ringer/vibrator 8316 is used to signal an incoming call, text message, calendar reminder, alarm clock reminder, or other notification to the user. During a receiving mode, the RF transmitter/receiver 8306 receives a voice signal or data signal from a remote station through the antenna 8302. A received voice signal is provided to the speaker 8320 while other received data signals are processed appropriately.

Additionally, a physical connector 8388 may be used to connect the mobile device 8300 to an external power source, such as an AC adapter or powered docking station, in order to recharge battery 8304. The physical connector 8388 may also be used as a data connection to an external computing device. The data connection allows for operations such as synchronizing mobile device data with the computing data on another device.

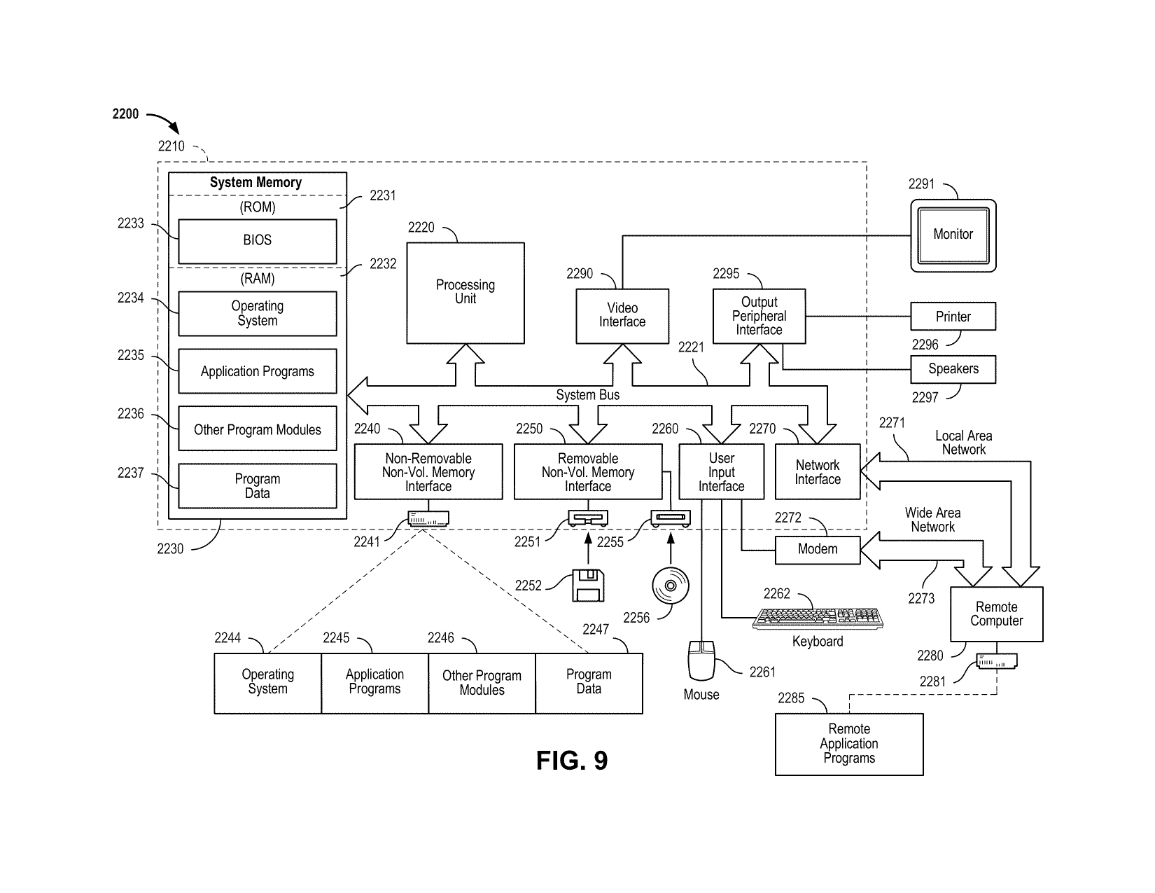

FIG. 9 is a block diagram of an embodiment of a computing system environment 2200. Computing system environment 2200 includes a general purpose computing device in the form of a computer 2210. Components of computer 2210 may include, but are not limited to, a processing unit 2220, a system memory 2230, and a system bus 2221 that couples various system components including the system memory 2230 to the processing unit 2220. The system bus 2221 may be any of several types of bus structures including a memory bus, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 2210 typically includes a variety of computer readable media. Computer readable media can be any available media that can be accessed by computer 2210 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 2210. Combinations of the any of the above should also be included within the scope of computer readable media.

The system memory 2230 includes computer storage media in the form of volatile and/or nonvolatile memory such as read only memory (ROM) 2231 and random access memory (RAM) 2232. A basic input/output system 2233 (BIOS), containing the basic routines that help to transfer information between elements within computer 2210, such as during start-up, is typically stored in ROM 2231. RAM 2232 typically contains data and/or program modules that are immediately accessible to and/or presently being operated on by processing unit 2220. By way of example, and not limitation, FIG. 9 illustrates operating system 2234, application programs 2235, other program modules 2236, and program data 2237.

The computer 2210 may also include other removable/non-removable, volatile/nonvolatile computer storage media. By way of example only, FIG. 9 illustrates a hard disk drive 2241 that reads from or writes to non-removable, nonvolatile magnetic media, a magnetic disk drive 2251 that reads from or writes to a removable, nonvolatile magnetic disk 2252, and an optical disk drive 2255 that reads from or writes to a removable, nonvolatile optical disk 2256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 2241 is typically connected to the system bus 2221 through an non-removable memory interface such as interface 2240, and magnetic disk drive 2251 and optical disk drive 2255 are typically connected to the system bus 2221 by a removable memory interface, such as interface 2250.

The drives and their associated computer storage media discussed above and illustrated in FIG. 9, provide storage of computer readable instructions, data structures, program modules and other data for the computer 2210. In FIG. 9, for example, hard disk drive 2241 is illustrated as storing operating system 2244, application programs 2245, other program modules 2246, and program data 2247. Note that these components can either be the same as or different from operating system 2234, application programs 2235, other program modules 2236, and program data 2237. Operating system 2244, application programs 2245, other program modules 2246, and program data 2247 are given different numbers here to illustrate that, at a minimum, they are different copies. A user may enter commands and information into computer 2210 through input devices such as a keyboard 2262 and pointing device 2261, commonly referred to as a mouse, trackball, or touch pad. Other input devices (not shown) may include a microphone, joystick, game pad, satellite dish, scanner, or the like. These and other input devices are often connected to the processing unit 2220 through a user input interface 2260 that is coupled to the system bus, but may be connected by other interface and bus structures, such as a parallel port, game port or a universal serial bus (USB). A monitor 2291 or other type of display device is also connected to the system bus 2221 via an interface, such as a video interface 2290. In addition to the monitor, computers may also include other peripheral output devices such as speakers 2297 and printer 2296, which may be connected through an output peripheral interface 2295.

The computer 2210 may operate in a networked environment using logical connections to one or more remote computers, such as a remote computer 2280. The remote computer 2280 may be a personal computer, a server, a router, a network PC, a peer device or other common network node, and typically includes many or all of the elements described above relative to the computer 2210, although only a memory storage device 2281 has been illustrated in FIG. 9. The logical connections depicted in FIG. 9 include a local area network (LAN) 2271 and a wide area network (WAN) 2273, but may also include other networks. Such networking environments are commonplace in offices, enterprise-wide computer networks, intranets and the Internet.

When used in a LAN networking environment, the computer 2210 is connected to the LAN 2271 through a network interface or adapter 2270. When used in a WAN networking environment, the computer 2210 typically includes a modem 2272 or other means for establishing communications over the WAN 2273, such as the Internet. The modem 2272, which may be internal or external, may be connected to the system bus 2221 via the user input interface 2260, or other appropriate mechanism. In a networked environment, program modules depicted relative to the computer 2210, or portions thereof, may be stored in the remote memory storage device. By way of example, and not limitation, FIG. 9 illustrates remote application programs 2285 as residing on memory device 2281. It will be appreciated that the network connections shown are exemplary and other means of establishing a communications link between the computers may be used.

The disclosed technology is operational with numerous other general purpose or special purpose computing system environments or configurations. Examples of well-known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosed technology may be described in the general context of computer-executable instructions, such as program modules, being executed by a computer. Generally, software and program modules as described herein include routines, programs, objects, components, data structures, and other types of structures that perform particular tasks or implement particular abstract data types. Hardware or combinations of hardware and software may be substituted for software modules as described herein.

The disclosed technology may also be practiced in distributed computing environments where tasks are performed by remote processing devices that are linked through a communications network. In a distributed computing environment, program modules may be located in both local and remote computer storage media including memory storage devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for managing data captured by a recording device, comprising:
acquiring a recording of user experiences captured throughout one or more days by the recording device;
generating context information, the context information including information associated with a user of the recording device, the context information including information associated with the recording device, the context information generated by one or more sensors;
identifying a particular situation from the recording;
detecting a tag event, the step of detecting includes automatically determining whether one or more rules associated with the recording device are satisfied by the context information and the particular situation, said one or more rules are configured for determining when to generate a set of one or more metadata tags for the recording;
automatically generating a set of one or more metadata tags for the recording responsive to the step of detecting, each of the one or more metadata tags including one or more keywords that describe the recording related to a location associated with the recording device, a timestamp associated with the recording, an event associated with the user, and/or a situation associated with the recording, the set of one or more metadata tags allowing subsequent search of the recording by the user or another user associated with one or more different recording devices; and
storing the set of one or more metadata tags in the recording device or in a remote storage device.

2. The method of claim 1, wherein:
the step of generating context information includes acquiring location information associated with the recording device, acquiring time information associated with the recording, acquiring calendar information associated with the user of the recording device, and acquiring biometric information associated with the user of the recording device; and
the location information includes a GPS location of the recording device, locations obtained from one or more cell towers, co-location from another computing device, locations based on one or more landmarks recognized, and locations identified from known map data, the time information includes a particular date and time associated with the recording, the calendar information includes a description of a calendar event associated with the user of the recording device, the biometric information includes a description of biological and physiological properties associated with the user of the of the recording device.

3. The method of claim 1, wherein:
the step of identifying a particular situation is performed using a voice recognition, a facial recognition, an eye-tracking system for detecting gaze of the user, gesture recognitions, a machine learning, and/or a pattern recognition technique on life recording; and
the particular situation is one of recognition of a particular person, recognition of a particular place, recognition of a particular emotion, or recognition of a particular object.

4. The method of claim 1, wherein:
the step of detecting includes comparing the particular situation with the one or more rules, the step detecting includes comparing the context information with the one or more rules.

5. The method of claim 1, further comprising:
identifying a first portion of the recording during which the particular situation is identified from the recording; and
generating a recording summary for the first portion of the recording responsive to the step of identifying, the recording summary including the first portion of the recording.

6. The method of claim 5, wherein:
the step of automatically generating a set of one or more metadata tags includes automatically generating a set of one or more metadata tags associated with the first portion of the recording based on the context information generated and the particular situation identified.

7. The method of claim 6, further comprising:
generating a metadata tag file associated with the recording device, wherein:
the metadata file is stored locally in the life recorder, in a remote storage device, or in the cloud.

8. The method of claim 7, wherein:
the metadata tag file stores searchable metadata tags related to a location, a timestamp, an event, and/or a situation; and
the searchable metadata tags include the set of one or more metadata tags associated with the first portion of the recording.

9. The method of claim 8, wherein:
the metadata tag file stores the set of one or more metadata tags associated with the first portion of the recording and a corresponding link to the recording summary that comprises the first portion of the recording.

10. The method of claim 8, wherein:
the metadata tag file stores the set of one or more metadata tags associated with the first portion of the recording and corresponding time stamps associated with the first portion of the recording; and
the corresponding time stamps include a start time stamp and an end time stamp indicating a particular time duration in the recording when the particular situation was identified.

11. The method of claim 8, further comprising:
receiving search criteria;
searching the metadata tags stored in the metadata tag file based on the search criteria in real-time or upon a triggering event to identify a portion of the recording based on the metadata tags; and
reporting the portion of the recording identified, the step of reporting includes displaying the portion of the recording identified on a display device.

12. An article of manufacture comprising:
a computer-readable storage medium having stored therein a computer program executable by a processor, the computer program comprising instructions for:
capturing one of a video recording, an audio recording, or an audiovisual recording of user experiences associated with a user by one or more recording devices;
analyzing the recording, the step of analyzing includes detecting a particular situation from the recording and comparing the particular situation detected with one or more requirements to determine when to generate a set of one or more metadata tags for the recording;
identifying a first portion of the recording during which the particular situation is detected responsive to the step of analyzing; and
automatically determining a set of one or more metadata tags to be associated with the first portion of the recording, the step automatically determining a set of one or more metadata tags includes generating one or more key phrases describing the first portion of the recording such that the recording can be searched based on the one or more key phrases.

13. The article of manufacture of claim 12, further comprising:
generating context information associated with the recording, the context information including location and time information associated with the recording devices, the context information includes calendar information and biometric information associated with the user; and
the particular situation is one of recognition of a particular person, recognition of a particular place, recognition of a particular emotion, or recognition of a particular object; wherein
the one or more recording devices include a depth sensing device to capture depth information.

14. The article of manufacture claim 12, further comprising:
generating a metadata tag file, wherein:
the metadata tag file stores one or more searchable metadata tags related to a location, a timestamp, an event, and a situation; and
the searchable metadata tags include the set of one or more metadata tags associated with the first portion of the recording.

15. The article of manufacture claim 14, wherein:
the metadata tag file stores the set of one or more metadata tags associated with the first portion of the recording and time stamps associated with the first portion of the recording; and
the time stamps include a start time stamp and an end time stamp indicating a particular time duration in the recording when the particular situation was identified.

16. The article of manufacture claim 14, further comprising:
searching the metadata tags stored in the metadata tag file to identify a portion of the recording based on search criteria; and
reporting the portion of the recording identified, the step of reporting includes displaying the portion of the recording identified on a display.

17. A system comprising:
one or more video devices, the one or more video devices capture a recording of user experiences associated with a user;
a memory, the memory stores the recording of user experiences; and
one or more processors, the one or more processors in communication with the one or more video devices and the memory, the one or more processors receive one or more rules for determining when to generate a set of one or more metadata tags for the recording, the one or more processors analyze the recording to detect context information associated with the recording and to identify a particular situation from the recording, the one or more processors determine when to generate a set of one or more metadata tags for the recording by comparing the set of one or more rules with the context information and the particular situation, the one or more processors generate a set of one or more metadata tags to be associated with a portion of the recording during which the particular situation was identified.

18. The system of claim 17, wherein:
the one or more video devices include a depth sensor to capture depth information; and
the one or more processors analyze the recording to identify the particular situation using a voice recognition, a facial recognition, an eye-tracking system for detecting gaze of the user, gesture recognitions, a machine learning, and/or a pattern recognition technique on the recording; and
the particular situation includes one of recognition of a particular person, recognition of a particular place, recognition of a particular emotion, or recognition of a particular object.

19. The system of claim 17, wherein:
the one or more processors analyze the recording to detect the context information by processing information captured by one or more sensors, the one or more sensors including at least one image sensor to capture digital and video recordings, at least one biometric sensor to capture biometric information associated with the user, and at least one environmental sensor to capture environmental information associated with the recording; and
the context information includes information associated with the user and information associated with the one or more video devices.

20. The system of claim 17, wherein:
the one or more processors generate a metadata tag file to store one or more searchable metadata tags related to a location, a timestamp, an event, and a situation associated with the recording, the searchable metadata tags stored in the metadata tag file include the set of one or more metadata tags associated with the portion of the recording.
